(19) United States
(12) Patent Application Publication
(10) Pub. No.: US 2024/0345411 A1
(43) Pub. Date: Oct. 17, 2024

(54) DISPLAY DEVICE AND HEAD MOUNTED DISPLAY

(71) Applicant: Sharp Display Technology Corporation, Kameyama City (JP)

(72) Inventors: MATTIA SIGNORETTO, Oxford (GB); David James Montgomery, Oxford (GB); Peter John Roberts, Oxford (GB); Naru Usukura, Kameyama City (JP); Manabu Daio, Kameyama City (JP)

(21) Appl. No.: 18/606,127

(22) Filed: Mar. 15, 2024

Related U.S. Application Data
(60) Provisional application No. 63/459,864, filed on Apr. 17, 2023.

(51) Int. Cl. G02B 30/25; G02B 27/01; G02B 27/09; G02B 27/28

(52) U.S. Cl. CPC G02B 30/25; G02B 27/0172; G02B 27/0955; G02B 27/283

(57) ABSTRACT

The display device of the present invention includes, in the following order toward a viewer: a display panel; a semi-transparent mirror; a lens; a Pancharatnam-Berry lens configured to cause one-handed circularly polarized light incident thereon that is left-handed circularly polarized light or right-handed circularly polarized light to converge while causing opposite-handed circularly polarized light incident thereon to diverge; and a circularly polarized light-selective reflector, a circularly polarized light-selective reflector side surface of the lens having a planar shape.

### CROSS-REFERENCE TO RELATED APPLICATIONS

The present application claims priority under 35 U.S.C. § 119 to U.S. Provisional Patent Application No. 63/459,864 filed on Apr. 17, 2023, the contents of which are incorporated herein by reference in their entirety.

### BACKGROUND OF THE INVENTION

### Field of the Invention

The present disclosure relates to display devices and head-mounted displays including the display devices.

### Description of Related Art

A head-mounted display (HMD) is a display device that outputs images such that a viewer (user) can see the images while wearing the HMD on the head. HMDs include, for example, immersive HMDs designed to cover both eyes to provide images displayed on the HMD to the viewer's field of view. Immersive HMDs create a deep sense of immersion by blocking out external light and are also called virtual reality (VR) devices.

Recent years have seen a growing attention to a virtual space called metaverse. VR-HMDs are a tool to access the virtual world, and thus their market is expected to grow. VR-HMDs, however, have an issue that the housing of the HMD is large, and are desired to be compact for popularization of VR-HMDs.

Techniques developed to achieve such a compact size include folded optics that utilizes the features of polarization (WO 2020/226867 and WO 2020/112965). WO 2020/226867 and WO 2020/112965 each disclose a technique of moving virtual images back and forth in the folded optics. Specifically, WO 2020/226867 and WO 2020/112965 show cases where varifocal lenses having an adjustable optical power are disposed at various positions in the optical system.

### BRIEF SUMMARY OF THE INVENTION

FIG. 24 is a schematic cross-sectional view of a display device using folded optics which makes an HMD compact. FIG. 24 is a schematic exploded cross-sectional view of a display device of a comparative embodiment. As shown in FIG. 24, a display device 100R of the comparative embodiment includes, in the following order toward a viewer U, a display panel 10, a circular polarizer 20, a semi-transparent mirror 30, a lens 40R, and a circularly polarized light-selective reflector 50. The circular polarizer 20 includes a first linearly polarizing plate 21 and a first quarter-wave plate 22. The folded optics shown in the comparative embodiment is also referred to as pancake lens optics.

When the display panel 10 is a liquid crystal panel, a second linearly polarizing plate facing the circular polarizer 20 across the display panel 10 may be disposed. In the display device 100R of the comparative embodiment, the functional layers and lenses may be bonded to one another or may be arranged with an air layer in between. The number of lenses may not be one and may be two or more.

The semi-transparent mirror 30 has a function of reflecting 50% of light incident thereon while transmitting the remaining 50%. Thus, 50% of light having been emitted from the display panel 10 and passed through the circular polarizer 20 passes through the semi-transparent mirror 30 to be emitted toward the viewer U, and the remaining 50% is reflected by the semi-transparent mirror 30 to be emitted toward the display panel 10. The light having passed through the semi-transparent mirror 30 to be emitted toward the viewer U is reflected by the circularly polarized light-selective reflector 50 to be emitted to the lens 40R. Then, 50% of light having passed through the lens 40R and reached the semi-transparent mirror 30 is reflected by the semi-transparent mirror 30 to be emitted toward the viewer U, while the remaining 50% passes through the semi-transparent mirror 30 to be emitted toward the display panel 10. In other words, 50% of light emitted from the display panel 10 is reflected by the semi-transparent mirror 30 toward the display panel 10 and thus is not perceived by the viewer U, which becomes lost light, and 25% of the light emitted from the display panel 10 goes back toward the display panel 10 through the semi-transparent mirror 30 and thus is not perceived by the viewer U, which also becomes lost light.

Examples of the circularly polarized light-selective reflector 50 include those having a structure including a second quarter-wave plate and a reflective linearly polarizing plate (e.g., reflective polarizer (product name: APF) available from 3M Company) and those having a structure including a cholesteric liquid crystal film.

The circularly polarized light-selective reflector 50 including a second quarter-wave plate and an APF emits linearly polarized light 1L. The circularly polarized light-selective reflector 50 including a cholesteric liquid crystal film emits circularly polarized light 2L.

The display device 100R using the folded optics of the comparative embodiment minimally has a structure using circularly polarized light as video light and including the semi-transparent mirror 30, the lens 40R, and the circularly polarized light-selective reflector 50 (e.g., cholesteric liquid crystal film). As current mainstream displays for HMDs are liquid crystal display devices, the display device 100R includes the first quarter-wave plate 22 on the first linearly polarizing plate 21 disposed on the liquid crystal panel, which serves as the display panel 10, so as to emit circularly polarized light. This display device 100R using folded optics can have a thin profile.

The display device 100R using folded optics preferably has a lens 40R whose semi-transparent mirror 30 side surface and circularly polarized light-selective reflector 50 side surface are sharply curved spherical surfaces. This configuration can increase the optical power of the lens 40R, enhancing the display characteristics of the display device 100R. To attach the circularly polarized light-selective reflector 50 to the circularly polarized light-selective reflector 50 side surface, which is a sharply curved spherical surface, of the lens 40R, the circularly polarized light-selective reflector 50 also preferably has a sharply curved spherical surface. A typical circularly polarized light-selective reflector, however, is available in a film form, so that a circularly polarized light-selective reflector having a sharply curved spherical surface is difficult to fabricate. For example, the circularly polarized light-selective reflector 50 has a flat shape or a shape with a gently curved surface (generally, with a radius of curvature R of 150 mm or greater). Thus, attaching the circularly polarized light-selective reflector 50 to the lens 40R having a sharply curved spherical surface is more difficult than attaching the circularly polarized light-selective reflector 50 to a planar surface, and highly possibly has an adverse effect on the productivity in terms of reliability and yield. Thus, it is difficult to achieve a display device 100R that has a thin profile and is excellent in both display characteristics and productivity.

WO 2020/226867 and WO 2020/112965 are both silent about a display device that has a thin profile and is excellent in both display characteristics and productivity.

In response to the above issues, an object of the present invention is to provide a display device that has a thin profile and is excellent in both display characteristics and productivity, and a head-mounted display including the display device.
(1) One embodiment of the present invention is directed to a display device including, in the following order toward a viewer: a display panel; a semi-transparent mirror; a lens; a Pancharatnam-Berry lens configured to cause one-handed circularly polarized light incident thereon that is left-handed circularly polarized light or right-handed circularly polarized light to converge while causing opposite-handed circularly polarized light incident thereon to diverge; and a circularly polarized light-selective reflector, a circularly polarized light-selective reflector side surface of the lens having a planar shape.
(2) In an embodiment of the present invention, the display device includes the structure (1), and the lens includes a first lens part and a second lens part.
(3) In an embodiment of the present invention, the display device includes the structure (1) or (2), the lens is a first lens, the circularly polarized light-selective reflector is a first circularly polarized light-selective reflector, the display device further includes, between the display panel and the semi-transparent mirror, in the following order toward the viewer: a second circularly polarized light-selective reflector; a display panel-side Pancharatnam-Berry lens; and a second lens, and a second circularly polarized light-selective reflector side surface of the second lens has a planar shape.
(4) In an embodiment of the present invention, the display device includes the structure (1), (2), or (3), and further includes a viewer-side Pancharatnam-Berry lens between the circularly polarized light-selective reflector and the viewer.
(5) Another embodiment of the present invention is directed to a head-mounted display including: the display device including any one of the structures (1), (2), (3), and (4), and a wearable part to be worn on a head of the viewer.

The present invention can provide a display device that has a thin profile and is excellent in both display characteristics and productivity, and a head-mounted display including the display device.

### BRIEF DESCRIPTION OF THE DRAWINGS

FIG. 1 is an exploded schematic view schematically showing a display device of Embodiment 1.

FIG. 2 is a schematic plan view of a PB lens.

FIG. 3 is a schematic view showing an example of convergence and divergence of light through a PB lens.

FIG. 4 is an example of an exploded cross-sectional view of the display device of Embodiment 1.

FIG. 5 is an example of an exploded cross-sectional view of the display device of Embodiment 1.

FIG. 6 is a plan view showing an example of a PB lens.

FIG. 7 is a plan view showing an example of a PB lens.

FIG. 8 is an example of a schematic cross-sectional view of a PB lens included in the display device of Embodiment 1.

FIG. 9 is an exploded schematic view schematically showing a display device of Modified Example 1 of Embodiment 1.

FIG. 10 is an exploded schematic view schematically showing a display device of Modified Example 2 of Embodiment 1.

FIG. 11 is an exploded schematic view schematically showing the mechanism of a ghost image that can be generated in the display device of Embodiment 1.

FIG. 12 is an exploded schematic view schematically showing a display device of Embodiment 2.

FIG. 13 is an exploded schematic view schematically showing a display device of Modified Example 1 of Embodiment 2.

FIG. 14 is an exploded schematic view schematically showing the mechanism of a ghost image that can be generated in the display device of Embodiment 2.

FIG. 15 is an exploded cross-sectional view schematically showing a display device of Embodiment 3.

FIG. 16 is a schematic plan view of the liquid crystal panel shown in FIG. 15.

FIG. 17 is a schematic perspective view showing an example of the appearance of a head-mounted display of Embodiment 4.

FIG. 18 includes an exploded schematic view schematically showing a display device of Comparative Example 1 and a simulation view.

FIG. 19 is an enlarged view of the region surrounded by the dashed line in FIG. 18.

FIG. 20 is a view showing the detailed simulation results of the display device of Comparative Example 1.

FIG. 21 includes an exploded schematic view schematically showing a display device of Example 1 and a simulation view.

FIG. 22 is an enlarged view of the region surrounded by the dashed line in FIG. 21.

FIG. 23 is a view showing the detailed simulation results of the display device of Example 1.

FIG. 24 is an exploded cross-sectional view schematically showing a display device of a comparative embodiment.

### DETAILED DESCRIPTION OF THE INVENTION

Hereinafter, the present invention is described in detail based on embodiments with reference to the drawings. The present invention is not limited to these embodiments.

### Embodiment 1

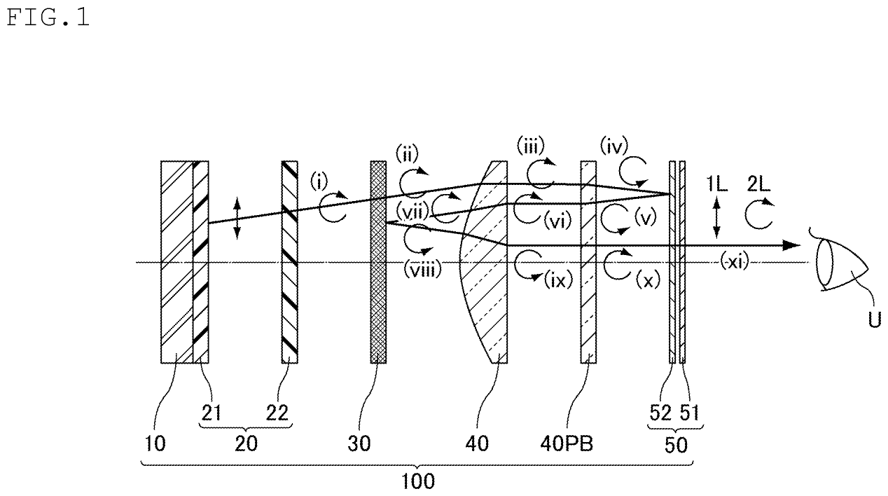

FIG. 1 is an exploded schematic view schematically showing a display device of Embodiment 1. As shown in FIG. 1, a display device 100 of the present embodiment includes, in the following order toward a viewer U: a display panel 10; a semi-transparent mirror 30; a lens 40; a Pancharatnam-Berry lens 40PB configured to cause one-handed circularly polarized light incident thereon that is left-handed circularly polarized light or right-handed circularly polarized light to converge while causing opposite-handed circularly polarized light incident thereon to diverge; and a circularly polarized light-selective reflector 50, a circularly polarized light-selective reflector 50 side surface of the lens 40 having a planar shape.

This configuration enables folded optics using the semi-transparent mirror 30, thus making the display device 100 thin. The configuration also can provide the optical power obtainable by making the circularly polarized light-selective reflector 50 side surface of the lens 40 spherical to the Pancharatnam-Berry lens 40PB, thus enhancing the display characteristics of the display device 100 while making the circularly polarized light-selective reflector 50 side surface of the lens 40 planar. For example, in the display device 100, the length of the optical system can be shortened, the modulation transfer function (MTF), which is an index of the lens performance, can be increased, and the field of view (FOV) can be widened. In addition, the circularly polarized light-selective reflector 50 side surface of the lens 40 having a planar shape allows easy attachment of the circularly polarized light-selective reflector 50 to the lens 40, improving the productivity.

Meanwhile, to shorten the length of the optical system, increase the MTF (an index of the lens performance), and widen the FOV (field of view) in the display device 100R of Comparative Embodiment 1, the circularly polarized light-selective reflector 50 side surface of the lens 40R needs to be spherical as described above. In this case, the circularly polarized light-selective reflector 50 ends up being attached to a spherical surface, which is more difficult than to a planar surface, and thus the productivity in terms of reliability and yield is highly likely to drop.

The display device 100 of the present embodiment, as shown in FIG. 1, includes the Pancharatnam-Berry lens 40PB in addition to the structure of the display device 100R of the comparative embodiment. This configuration can make the Pancharatnam-Berry lens 40PB partially responsible for the optical power from the spherical surface of the lens 40. The configuration thus can make the circularly polarized light-selective reflector 50 side surface of the lens 40 planar to allow easy attachment of the circularly polarized light-selective reflector 50, improving the productivity.

WO 2020/226867 and WO 2020/112965 state configurations in which the optical system includes a PB lens, but these documents do not disclose lens shapes when the optical system includes both a lens and a PB lens.

Also, WO 2020/226867 and WO 2020/112965 disclose techniques for moving virtual images and no consideration is made on image quality improvement in the optical system. In contrast, the display device 100 of the present embodiment can improve the image quality. Specifically, the display device 100 of the present embodiment can optimize the image quality and achieve a wide FOV. This means that the display device 100 of the present embodiment differs from the display devices of WO 2020/226867 and WO 2020/112965 in purpose of placing the PB lens. The details of the present embodiment are described below. The Pancharatnam Berry lens is also hereinbelow referred to as the PB lens.

As shown in FIG. 1, the display device 100 of the present embodiment includes, in the following order toward the viewer U, the display panel 10, the circular polarizer 20, the semi-transparent mirror 30, the lens 40, the PB lens 40PB, and the circularly polarized light-selective reflector 50.

FIG. 1 shows an example where the circular polarizer 20 includes a laminate of the first linearly polarizing plate 21 and the first quarter-wave plate 22. Although the exploded cross-sectional view herein shows the components with spaces in between, the components may be bonded to one another or may be spaced from one another. In other words, the functional layers and lenses may be bonded to one another or may be arranged with an air layer in between. The number of lenses may not be one and may be two or more.

As shown in FIG. 1, the display panel 10 emits light (display light) toward the viewer U and the first linearly polarizing plate 21 converts the display light from the display panel 10 to linearly polarized light. The linearly polarized light having passed through the first quarter-wave plate 22 is converted to circularly polarized light ((i) in FIG. 1). When the circularly polarized light is circularly polarized light rotating clockwise, the circularly polarized light rotating clockwise passes through the semi-transparent mirror 30 ((ii) in FIG. 1), and then through the lens 40 with no change in rotation direction ((iii) in FIG. 1). The circularly polarized light rotating clockwise emitted from the lens 40 then passes through the PB lens 40PB to be converted to circularly polarized light rotating in reverse, i.e., counterclockwise ((iv) in FIG. 1).

The circularly polarized light rotating counterclockwise emitted from the PB lens 40PB is selectively reflected by the circularly polarized light-selective reflector 50 ((v) in FIG. 1). The reflected circularly polarized light rotating counterclockwise then again passes through the PB lens 40PB to be converted to circularly polarized light rotating in reverse, i.e., clockwise ((vi) in FIG. 1). The circularly polarized light rotating clockwise emitted from the PB lens 40PB passes through the lens 40 with no change in rotation direction ((vii) in FIG. 1), and is then reflected by the semi-transparent mirror 30 to be converted to circularly polarized light rotating counterclockwise ((viii) in FIG. 1).

The circularly polarized light rotating counterclockwise emitted from the semi-transparent mirror 30 passes through the lens 40 with no change in rotation direction ((ix) in FIG. 1). The circularly polarized light rotating counterclockwise emitted from the lens 40 passes through the PB lens 40PB to be converted to circularly polarized light rotating in reverse, i.e., clockwise ((x) in FIG. 1). The circularly polarized light rotating clockwise emitted from the PB lens 40PB passes through the circularly polarized light-selective reflector 50 and is emitted toward the viewer U ((xi) in FIG. 1).

The display device 100 of the present embodiment is based on the folded optics that causes light to be reflected between the semi-transparent mirror 30 and the circularly polarized light-selective reflector 50, so that the path of light (display light) emitted from the display panel 10 toward the viewer U is folded before reaching the viewer U. This enables a long optical path while reducing the thickness of the display device 100.

### (Display Panel)

The display panel 10 preferably includes pixels. The pixels are display units for displaying images and include, in the case of color display, red, blue, and green pixels.

The display panel 10 may include a TFT substrate in which thin film transistors (TFTs) are arranged. The TFT substrate may include, on a supporting substrate, gate lines extending parallel to one another and source lines extending parallel to one another in a direction in which they intersect the gate lines via a gate insulator. The gate lines and the source lines may be formed in a grid pattern in a plan view. The regions defined by the gate lines and the source lines correspond to pixels.

The supporting substrate is preferably a transparent substrate and may be, for example, a glass substrate or a plastic substrate.

TFTs serving as switching elements may be arranged for the respective pixels at or near the respective intersections of the gate lines and the source lines. The gate terminal of each TFT may be connected to the corresponding gate line, the source terminal of the TFT may be connected to the corresponding source line, and the drain terminal of the TFT may be connected to the corresponding pixel electrode. The display panel 10 may include a common electrode to which a common electrode voltage is applied, in addition to the pixel electrodes.

The display panel 10 may be an organic light emitting diode (OLED) panel including OLEDs or a quantum dot light emitting diode (QD-LED) panel including QD-LEDs. The OLEDs and QD-LEDs herein are also referred to simply as light emitting diodes (LEDs) when no distinction is made between them.

The configuration of each light emitting diode is not limited, and may be, for example, a stack including in the following order a cathode, an electron transport layer, a light-emitting layer, a hole transport layer, and an anode.

The materials of the cathode and the anode are not limited, and may each be, for example, a transparent conductive material such as indium tin oxide (ITO), indium zinc oxide (IZO), In₃O₃, SnO₂, or ZnO, aluminum, silver, or an alloy of these.

In the case of a top-emitting LED, the pixel electrodes in the TFT substrate may be used as the anode while the common electrode may be used as the cathode. Reflective electrode(s) formed from aluminum, silver, or an alloy of these may be used as the anode while any of the above transparent conductive materials may be used as the cathode.

The hole transport layer transports holes injected from the anode to the light-emitting layer. The material of the hole transport layer is not limited and may be, for example, an amine-based compound such as N,N,N′,N′-tetraphenylbenzidine or a derivative thereof.

The electron transport layer transports electrons injected from the cathode to the light-emitting layer. The material of the electron transport layer is not limited and may be, for example, a phenanthroline derivative such as 2,9-dimethyl-4,7-diphenyl-1,10-phenanthroline (BCP), a quinoline derivative such as tris(8-quinolinolato)aluminum (Alq3), an azaindolizine derivative, an oxadiazole derivative, a perylene derivative, a pyridine derivative, a pyrimidine derivative, a quinoxaline derivative, a diphenylquinone derivative, or a nitro-substituted fluorene derivative.

An electron injection layer may be disposed between the cathode and the electron transport layer. A hole injection layer may be disposed between the anode and the hole transport layer. The material of the electron injection layer can be an inorganic insulating material. Examples thereof include oxides of an alkali metal, halides of an alkali metal, oxides of an alkaline earth metal, and halides of an alkaline earth metal.

When the display panel 10 is an OLED panel, the light-emitting layer may include as a luminous material a fluorescent material or a phosphorescent material, for example.

A red fluorescent material may be any material that emits red fluorescence, and may be, for example, a tetraaryl diindenoperylene derivative or another perylene derivative, a europium complex, a benzopyran derivative, a rhodamine derivative, a benzothioxanthene derivative, or a porphyrin derivative.

A green fluorescent material may be any material that emits green fluorescence, and may be, for example, a coumarin derivative, a quinacridone derivative, or an anthracene derivative.

A blue fluorescent material may be any material that emits blue fluorescence, and may be, for example, a distyrylamine derivative, a fluoranthene derivative, a pyrene derivative, perylene, a perylene derivative, an anthracene derivative, a benzoxazole derivative, a benzothiazole derivative, a benzimidazole derivative, a chrysene derivative, a phenanthrene derivative, a distyrylbenzene derivative, or tetraphenyl butadiene.

A phosphorescent material may be any material that emits phosphorescence, and may be, for example, a metal complex such as a complex of iridium, ruthenium, platinum, osmium, rhenium, or palladium. The metal complex preferably has at least one ligand having a phenylpyridine skeleton, a bipyridyl skeleton, or a porphyrin skeleton, for example.

Examples of the red phosphorescent material include tris(1-phenylisoquinoline)iridium, bis[2-(2′-benzo[4,5-α]thienyl)pyridinato-N,C3′]iridium(acetylacetonate) (btp2Ir(acac)), platinum(II) 2,3,7,8,12,13,17,18-octaethyl-12H,23H-porphyrin, bis[2-(2′-benzo[4,5-α]thienyl)pyridinato-N,C3′]iridium, and bis(2-phenylpyridine)iridium(acetylacetonate).

Examples of the green phosphorescent material include fac-tris(2-phenylpyridine)iridium (Ir(ppy)3), bis(2-phenylpyridinato-N,C2′)iridium(acetylacetonate), and fac-tris[5-fluoro-2-(5-trifluoromethyl-2-pyridine)phenyl-C,N] iridium.

Examples of the blue phosphorescent material include bis[4,6-difluorophenylpyridinato-N,C2′]-picolinato-iridium, tris[2-(2,4-difluorophenyl)pyridinato-N,C2′]iridium, bis[2-(3,5-trifluoromethyl)pyridinato-N,C2′]-picolinato-iridium, and bis(4,6-difluorophenylpyridinato-N,C2′)iridium(acetylacetonate).

The fluorescent material and the phosphorescent material are also called dopants. The light-emitting layer may contain a host material that transports electric charges to dopants. Examples of the host material include acene derivatives (acene-based compounds) such as anthracene derivatives and tetracene derivatives, distyryl arylene derivatives, perylene derivatives, distyryl benzene derivatives, distyryl amine derivatives, quinolinolato-based metal complexes such as tris(8-quinolinolato)aluminum complex (Alq3), triaryl amine derivatives such as triphenylamine tetramer, oxadiazole derivatives, silole derivatives, carbazole derivatives such as 3-phenyl-4-(1′-naphthyl)-5-phenylcarbazole and 4,4′-N,N′-dicarbazolebiphenyl (CBP), oligothiophene derivatives, benzopyran derivatives, triazole derivatives, benzoxazole derivatives, benzothiazole derivatives, quinoline derivatives, and 4,4′-bis(2,2′-diphenylvinyl)biphenyl (DPVBi). The host material can appropriately be used in combination with the fluorescent material and/or the phosphorescent material.

When the display panel 10 is a QD-LED panel, the light-emitting layer may include quantum dots as the luminous material. The quantum dots are nano-sized (e.g., average particle size of from 2 to 10 nm) semiconductor crystals that exhibit optical characteristics governed by quantum mechanics. Examples thereof include colloidal particles each of which is composed of about 10 to 50 atoms.

Examples of the quantum dots include those formed from a compound such as cadmium selenide (CdSe), cadmium telluride (CdTe), cadmium sulfide (CdS), lead sulfide (PbS), or indium phosphide (InP), or an alloy such as CdSeS.

Examples of the quantum dots include core-type quantum dots each having a homogeneous internal composition consisting of monocomponent semiconductor crystals, alloy-type quantum dots each formed from an alloy of several types of semiconductors, and core/sell-type quantum dots each formed from a core-type or alloy-type quantum dot whose surface is coated with a semiconductor compound. Adjusting the particle size of the quantum dots enables adjustment of the peak emission wavelength. Also, varying the composition or internal structure of the quantum dots enables adjustment of the optical characteristics and electronic characteristics.

Each pixel may be provided with a light emitting diode (OLED or QD-LED). In the case of an OLED panel or a QD-LED panel, a red pixel, a green pixel, and a blue pixel may respectively be provided with a red LED (OLED or QD-LED) including a red luminous material-containing light-emitting layer, a green LED including a green luminous material-containing light-emitting layer, and a blue LED including a blue luminous material-containing light-emitting layer.

An OLED that emits white fluorescence or phosphorescence can also be fabricated using a combination of any of the fluorescent or phosphorescent materials. In the case of an OLED panel, color filters including a red, green, or blue resin layer may be stacked on white OLEDs to define red pixels, green pixels, and blue pixels.

In the case of a QD-LED panel, a color OLED layer including a red OLED, a green OLED, or a blue OLED or a color filter may be stacked on a quantum dot layer of a single color such as white or blue to define red pixels, green pixels, and blue pixels.

The pixel arrangement is not limited, and may be the Pentile arrangement in which the number of green pixels is twice the number of red pixels and the number of blue pixels or may be the real RGB arrangement in which red pixels, green pixels, and blue pixels are arranged at a ratio of 1:1:1.

### (Circular Polarizer)

The circular polarizer 20 converts display light from the display panel 10 to circularly polarized light before transmitting the display light. The circular polarizer 20 in the present embodiment includes the first linearly polarizing plate 21 and the first quarter-wave plate 22. The first linearly polarizing plate 21 converts the display light to linearly polarized light. The first quarter-wave plate 22 converts the linearly polarized light to circularly polarized light.

The first linearly polarizing plate 21 may be any plate that transmits linearly polarized light vibrating in a certain direction, and may be a polarizing plate common in the field of display devices. The linearly polarizing plate may be an absorptive one or a reflective one.

The absorptive polarizing plate has a function of absorbing light vibrating in a certain direction while transmitting polarized light (linearly polarized light) vibrating in a direction perpendicular to the certain direction. The absorptive polarizing plate has a transmission axis and an absorption axis orthogonal to the transmission axis. Examples of the absorptive linearly polarizing plate include one obtained by adsorbing iodine compound molecules on a polyvinyl alcohol film, uniaxially stretching the film, and sandwiching the film between triacetyl cellulose (TAC) films.

The reflective polarizing plate has a function of reflecting light vibrating in a certain direction while transmitting polarized light (linearly polarized light) vibrating in a direction perpendicular to the certain direction. The reflective polarizing plate has a transmission axis and a reflection axis orthogonal to the transmission axis. Examples of the reflective linearly polarizing plate include a reflective polarizing plate (e.g., APCF available from Nitto Denko Corporation, DBEF available from 3M Company) obtained by uniaxially stretching a co-extruded film formed from two types of resins and a wire-grid polarizing plate composed of metal wire arrays. Examples of the wire-grid polarizing plate include one in which metal wires with a diameter of about from 10 μm to 100 μm are arranged at a pitch of from 20 μm to 200 μm.

The first quarter-wave plate 22 may be any phase difference plate that introduces a phase difference of a quarter of a wavelength to incident light. The first quarter-wave plate 22 is a phase difference plate that introduces an in-plane phase difference of a quarter of a wavelength (precisely, 137.5 nm) to light with a wavelength of 550 nm, for example. The in-plane phase difference to be introduced is 120 nm or more and 150 nm or less.

The circular polarizer 20 may be a cholesteric liquid crystal element. When the circular polarizer 20 is a cholesteric liquid crystal element, the cholesteric liquid crystal element converts display light emitted from the display panel 10 to circularly polarized light.

When light is viewed from the direction opposing the light propagation direction, light waves whose vibration direction of the electric displacement vector rotates clockwise as the light waves propagate are called circularly polarized light rotating clockwise, and those whose vibration direction of the electric displacement vector rotates counterclockwise as the light waves propagate are called circularly polarized light rotating counterclockwise. The “circularly polarized light” encompasses not only perfectly circularly polarized light (ellipticity (short axis/long axis)=1.00) but also elliptically polarized light having an ellipticity of 0.90 or more and less than 1.00.

Examples of the cholesteric liquid crystal element include one in which a cholesteric liquid crystal layer including cholesteric liquid crystals is sandwiched between paired substrates. Subjecting the substrates to alignment treatment to control the alignment azimuth of the cholesteric liquid crystals enables fabrication of a cholesteric liquid crystal element that reflects circularly polarized light rotating clockwise or counterclockwise while transmitting circularly polarized light rotating in the reverse direction. The cholesteric liquid crystal layer can be fabricated to have a thickness of several micrometers, so that the distance between the display panel 10 and the semi-transparent mirror 30 can be reduced. The substrate of the display panel 10 closer to the viewer may be used as a supporting substrate and a cholesteric liquid crystal layer may be formed on the surface of the substrate of the display panel 10 closer to the viewer.

### (Semi-Transparent Mirror)

The semi-transparent mirror 30 is an optical element that reflects part of incident light while transmitting the rest of the incident light. The reflectance and the transmittance of the semi-transparent mirror 30 are not limited. For example, the semi-transparent mirror 30 reflects from 30% to 70% of incident light while transmitting the rest, and preferably reflects 50% of incident light while transmitting the remaining 50%. The semi-transparent mirror 30 can be formed from, for example, a metal film or a dielectric multilayer film. Controlling the film thickness enables control of the transmittance and reflectance.

### (Lens)

The circularly polarized light-selective reflector 50 side surface of the lens 40 has a planar shape. A planar shape or being planar herein means a shape with a radius of curvature R of 150 mm or greater. A spherical shape or being spherical herein means a shape with a radius of curvature R of smaller than 150 mm.

The lens 40 may be any lens that enlarges/reduces images on the display panel 10. The combination of the lens 40 and the PB lens 40PB causes the viewer to perceive an enlarged image (virtual image) of the display image displayed on the display panel 10. The combination of the lens 40 and the PB lens 40PB preferably defines an aspherical lens designed to concentrate lights having passed through the combination of the lens 40 and the PB lens 40PB to the eyes of the viewer U. The lens 40 may be a refractive lens or a diffractive lens.

The refractive lens can be one usually used in the field of HMDs. Examples thereof include refractive lenses having curved surface(s) (convex surface(s)), including plano-convex lenses, double-convex lenses, and meniscus lenses. A Fresnel lens may be used in combination. The refractive lens is preferably disposed such that the convex surface faces the display panel 10. The refractive lens may be an achromatic lens fabricated by attaching two lenses with different wavelength dispersions to each other, or may be a combination of a plurality of lenses. For example, two lenses are used in a commonly used optical system in order to achieve an appropriate optical power. Possibly, one of the two lenses closer to the display device is a double-convex lens while the other lens closer to the viewer is a plano-convex lens with its convex Fresnel lens surface facing the panel.

Examples of the diffractive lens include transparent holographic optical elements. A transparent holographic optical element used as the diffractive lens can form an image on the display panel 10 by utilizing the diffraction phenomenon of light described above. The holographic film can be one imparted with the desired optical characteristics by interference lithography using lights corresponding to the incident light and the emission light. A holographic film is also producible by a method called computer-generated holography (CGH) used to achieve the desired optical characteristics by individually illuminating small areas of an object.

### (Pb Lens)

The display device 100 of the present embodiment includes the PB lens 40PB between the lens 40 and the circularly polarized light-selective reflector 50. The PB lens 40PB causes one-handed circularly polarized light that is left-handed circularly polarized light or right-handed circularly polarized light incident thereon to converge while causing the opposite-handed circularly polarized light incident thereon to diverge. This configuration can enhance the display characteristics of the display device 100 using folded optics. For example, the image quality can be more favorably optimized and, in particular, a wide field of view (FOV) can be achieved in folded optics. The PB lens 40PB is also referred to as a Pancharatnam-Berry phase (PBP) lens. The PB lens 40PB is a diffractive lens.

The present embodiment uses the PB lens 40PB which is a diffractive lens capable of bending the traveling direction of light through its planar surface, instead of making the circularly polarized light-selective reflector side surface of the lens spherical. The PB lens 40PB causes one-handed circularly polarized light that is left-handed circularly polarized light or right-handed circularly polarized light incident thereon to converge while rotating the one-handed circularly polarized light in reverse, and causes the opposite-handed circularly polarized light incident thereon to diverge while rotating the opposite-handed circularly polarized light in reverse.

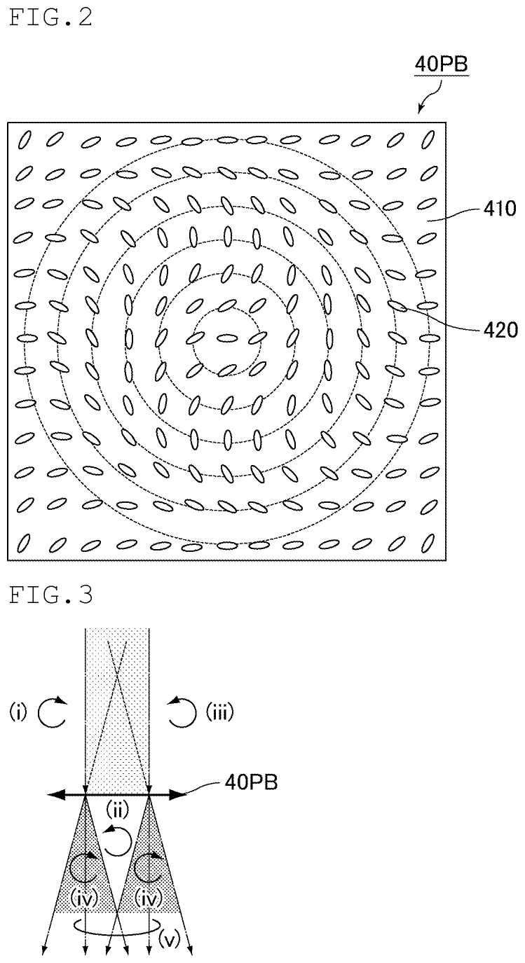

FIG. 2 is a schematic plan view of a PB lens. The PB lens 40PB in the present embodiment includes, as shown in FIG. 2, a supporting substrate 410 and liquid crystal molecules 420 placed on the supporting substrate 410 and periodically aligned. The periodic alignment of the liquid crystal molecules 420 causes diffraction to achieve the lens function.

FIG. 3 is a schematic view showing an example of convergence and divergence of light through a PB lens. As shown in FIG. 3, for example, when one-handed circularly polarized light that is left-handed circularly polarized light or right-handed circularly polarized light is incident on the PB lens 40PB, the PB lens 40PB causes the one-handed circularly polarized light to converge while converting the one-handed circularly polarized light to the opposite-handed circularly polarized light by rotating the one-handed circularly polarized light in reverse. When the opposite-handed circularly polarized light is incident on the PB lens 40PB, the PB lens 40PB causes the opposite-handed circularly polarized light to diverge while converting the opposite-handed circularly polarized light to the one-handed circularly polarized light by rotating the opposite-handed circularly polarized light in reverse.

Specifically, as shown in FIG. 3, right-handed circularly polarized light ((i) in FIG. 3) incident on the PB lens 40PB is rotated in reverse to be converted to left-handed circularly polarized light and converges ((ii) in FIG. 3). Left-handed circularly polarized light ((iii) in FIG. 3) incident on the PB lens 40PB is rotated in reverse to be converted to right-handed circularly polarized light and diverges ((iv) in FIG. 3). In this manner, switching the rotation direction of circularly polarized light incident on the PB lens 40PB enables switching between divergence and convergence of light at the focal point f. The rotation direction of circularly polarized light emitted from the PB lens 40PB is opposite to the rotation direction of circularly polarized light incident on the PB lens 40PB. Non-diffracting circularly polarized light passes through the PB lens 40PB as is with no change in rotation direction and no convergence or divergence ((v) in FIG. 3).

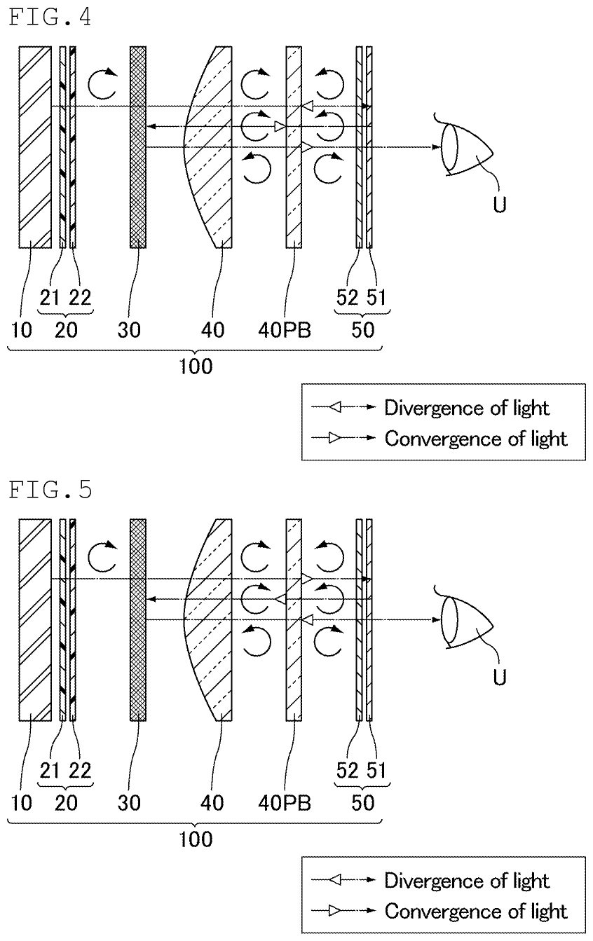

FIG. 4 and FIG. 5 are each an example of an exploded cross-sectional view of the display device of Embodiment 1. The display device 100 of the present embodiment may be of either of the two types shown in FIG. 4 and FIG. 5 which are different in direction of arrows representing divergence and convergence of light through the PB lens 40PB. FIG. 4 shows a mode where light emitted from the display panel 10 diverges twice and converges once through the PB lens 40PB before being emitted toward the viewer U. FIG. 5 shows a mode where light emitted from the display panel 10 converges twice and diverges once through the PB lens 40PB before being emitted toward the viewer U. The long axis direction of the liquid crystal molecules in the PB lens rotates differently when the front surface of the PB lens is observed and when the back surface of the PB lens is observed. For example, when the liquid crystal molecules are arranged with their long axis direction rotating counterclockwise in observation of the front surface of the PB lens, the liquid crystal molecules appear to be arranged with their long axis direction rotating clockwise in observation of the back surface of the PB lens. In other words, when right-handed circularly polarized light incident on the front surface of the PB lens diverges, right-handed circularly polarized light incident on the back surface of the PB lens converges.

Light emitted from the display panel 10 preferably diverges twice and converges once through the PB lens 40PB before being emitted toward the viewer U. This configuration enables effective enhancement of the display characteristics.

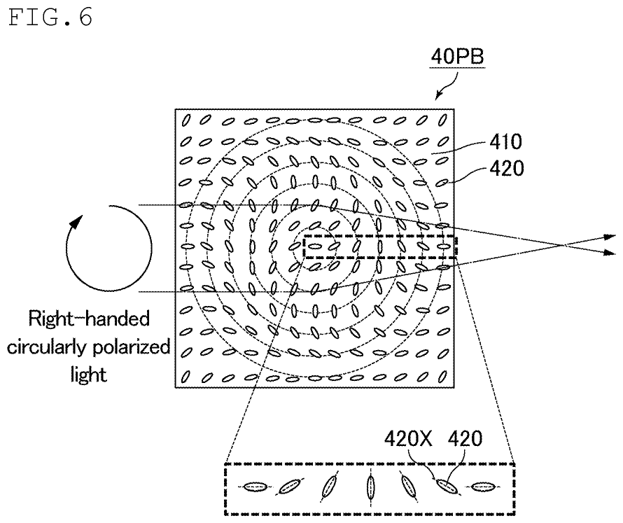

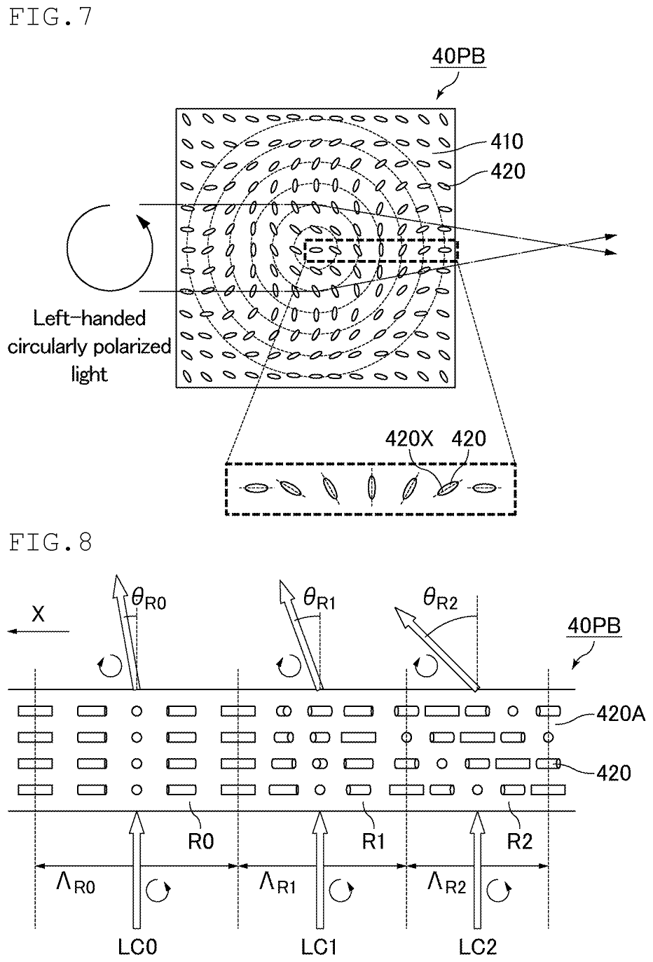

FIG. 6 and FIG. 7 are each a plan view of an example of a PB lens. The plan views shown in FIG. 6 and FIG. 7 are the PB lens as viewed by the viewer U. There are two types of structures for the PB lens 40PB; one is the structure in which, as shown in FIG. 6, a long axis 420X direction of the liquid crystal molecules 420 rotates counterclockwise from the center to the outside, and the other is the structure in which, as shown in FIG. 7, the long axis 420X direction of the liquid crystal molecules 420 rotates clockwise from the center to the outside. These structures are different in effect on polarization.

As shown in FIG. 6, preferably, the PB lens 40PB has a structure in which a supporting substrate 410 and liquid crystal molecules 420 placed on the supporting substrate 410 are included and the long axis 420X direction of the liquid crystal molecules 420 rotates counterclockwise from the center to the outside of the PB lens 40PB in a plan view of the PB lens 40PB as viewed by the viewer U, and right-handed circularly polarized light from the display panel 10 is incident on the PB lens 40PB. This configuration, as shown in FIG. 4, causes light from the display panel 10 to diverge twice and converge once through the PB lens 40PB before being emitted toward the viewer U.

As shown in FIG. 7, preferably, the PB lens 40PB has a structure in which a supporting substrate 410 and liquid crystal molecules 420 placed on the supporting substrate 410 are included and the long axis 420X direction of the liquid crystal molecules 420 rotates clockwise from the center to the outside of the PB lens 40PB in a plan view of the PB lens 40PB as viewed by the viewer U, and left-handed circularly polarized light from the display panel 10 is incident on the PB lens 40PB. This configuration also causes light from the display panel 10 to diverge twice and converge once through the PB lens 40PB before being emitted toward the viewer U.

As shown in FIG. 6, the PB lens 40PB may have a structure in which the supporting substrate 410 and the liquid crystal molecules 420 placed on the supporting substrate 410 are included and the long axis 420X direction of the liquid crystal molecules 420 rotates counterclockwise from the center to the outside of the PB lens 40PB in a plan view of the PB lens 40PB as viewed by the viewer U, and left-handed circularly polarized light from the display panel 10 may be incident on the PB lens 40PB. This configuration causes light from the display panel 10 to converge twice and diverge once through the PB lens 40PB before being emitted toward the viewer U.

Also, as shown in FIG. 7, the PB lens 40PB may have a structure in which a supporting substrate 410 and liquid crystal molecules 420 placed on the supporting substrate 410 are included and the long axis 420X direction of the liquid crystal molecules 420 rotates clockwise from the center to the outside of the PB lens 40PB in a plan view of the PB lens 40PB as viewed by the viewer U, and right-handed circularly polarized light from the display panel 10 is incident on the PB lens 40PB. This configuration also causes light from the display panel 10 to converge twice and diverge once through the PB lens 40PB before being emitted toward the viewer U.

The rotation direction of circularly polarized light to be incident on the PB lens 40PB can be controlled by switching the fast axis and the slow axis of the first quarter-wave plate 22.

The PB lens 40PB can be produced, for example, by the method disclosed in WO 2019/189818.

FIG. 8 is an example of a schematic cross-sectional view of a PB lens included in the display device of Embodiment 1. The PB lens 40PB, as shown in FIG. 8, includes an optically anisotropic layer 420A containing the liquid crystal molecules 420. For example, the PB lens 40PB diffracts circularly polarized light incident thereon in a predetermined direction before transmitting the light. In FIG. 8, the incident light is left-handed circularly polarized light.

As shown in FIG. 8, the optically anisotropic layer 420A shown in FIG. 8 includes three regions R0, R1, and R2 from the left in FIG. 8, and the regions have different lengths A of one period. Specifically, the order of length A of one period is regions R0, R1, and R2, from longest to shortest. The regions R1 and R2 may each have a structure in which the optic axis is twist-rotated in the thickness direction of the optically anisotropic layer (hereinafter, also referred to as a twisted structure). Stacking two such twisted structures can increase the diffraction efficiency for light with wide wavelength ranges and/or light with a large angle of incidence.

In the display device 100, left-handed circularly polarized light LC1 incident on the in-plane region R1 of the optically anisotropic layer 420A is transmitted after being diffracted at a predetermined angle in the direction of the arrow X, i.e., one direction in which the orientation of the optic axis of the liquid crystal molecules 420 varies while rotating continuously, from the incident direction.

Similarly, left-handed circularly polarized light LC2 incident on the in-plane region R2 of the optically anisotropic layer 420A is transmitted after being diffracted at a predetermined angle in the direction of the arrow X from the incident direction. Also, left-handed circularly polarized light LC0 incident on the in-plane region R0 of the optically anisotropic layer 420A is transmitted after being diffracted at a predetermined angle in the direction of the arrow X from the incident direction.

The one period ∧_{R2} of the liquid crystal alignment pattern of the region R2 is shorter than the one period ∧_{R1} of the liquid crystal alignment pattern of the region R1. Thus, in the optically anisotropic layer 420A, as shown in FIG. 8, the angle of diffraction θ_{R2} provided to light incident on and transmitted through the region R2 is larger than the angle of diffraction θ_{R1} provided to light incident on and transmitted through the region R1. Also, the one period ∧_{R0} of the liquid crystal alignment pattern of the region R0 is longer than the one period ∧_{R1} of the liquid crystal alignment pattern of the region R1. Thus, as shown in FIG. 8, the angle of diffraction θ_{R0} provided to light incident on and transmitted through the region R0 is smaller than the angle of diffraction θ_{R1} provided to light incident on and transmitted through the region R1.

Here, diffraction of light by the optically anisotropic layer having a liquid crystal alignment pattern in which the orientation of the optic axis of the liquid crystal molecules varies while continuously rotating in a plane involves an issue that the diffraction efficiency decreases as the angle of diffraction increases, i.e., the intensity of the diffracted light decreases. This means that when the optically anisotropic layer has a structure including regions with different lengths of one period, in which the orientation of the optic axis of the liquid crystal molecules is rotated by 180°, the angle of diffraction differs depending on the position of incidence of light, resulting in a difference in quantity of diffracted light depending on the in-plane position of incidence of light. In other words, the structure produces a region where transmitted, diffracted light weakens at certain in-plane positions of incidence of light.

Meanwhile, the PB lens 40PB of the present embodiment includes the regions where liquid crystal molecules are twist-rotated in the thickness direction in the optically anisotropic layer and the twist angle in the thickness direction differs from region to region. In the example in FIG. 8, the twist angle φ_{R2} in the thickness direction of the region R2 is larger than the twist angle φ_{R1} in the thickness direction of the region R1 in the optically anisotropic layer 420A. The region R0 has no twisted structure in the thickness direction. This can reduce or prevent a decrease in diffraction efficiency of diffracted light.

In the example in FIG. 8, the regions R1 and R2 larger in angle of diffraction than the region R0 each have a twisted structure. This can reduce or prevent a decrease in quantity of light diffracted by the regions R1 and R2. Also, the region R2 larger in angle of diffraction than the region R1 is also larger in twist angle of the twisted structure than the region R1. This can reduce or prevent a decrease in quantity of light diffracted by the region R2. The configuration can equalize the quantities of transmitted lights regardless of the in-plane positions of incidence of light.

As described above, in an in-plane region where the optically anisotropic layer provides a large angle of diffraction in the PB lens 40PB of the present embodiment, incident light is diffracted by passing through a layer with a large twist angle in the thickness direction. Meanwhile, in an in-plane region where the optically anisotropic layer provides a small angle of diffraction, incident light is diffracted by passing through a layer with a small twist angle in the thickness direction. In other words, the PB lens 40PB can produce transmitted light brighter than incident light by setting the in-plane twist angle in the thickness direction according to the angle of diffraction provided by the optically anisotropic layer. Thus, the PB lens 40PB can reduce the diffraction angle dependence of the quantity of transmitted light in the plane.

The angle of light diffraction in the plane of the optically anisotropic layer 420A increases as the one period A of the liquid crystal alignment pattern becomes shorter. Also, the twist angle in the thickness direction in the plane of the optically anisotropic layer 420A is larger in a region with a short one period A, in which the orientation of the optic axis rotates by 1800 in the direction of the arrow X in the liquid crystal alignment pattern, than in a region with a long one period A. In the PB lens 40PB, for example, as shown in FIG. 8, the one period ∧_{R2} of the liquid crystal alignment pattern in the region R2 of the optically anisotropic layer 420A is shorter than the one period ∧_{R1} of the liquid crystal alignment pattern in the region R1, and the twist angle φ_{R2} in the thickness direction is larger than the twist angle φ_{R1}. In other words, the region R2 in the optically anisotropic layer 420A on the light incident side more diffracts light.

Thus, when the in-plane twist angle φ in the thickness direction is set for the one period A of the liquid crystal alignment pattern in question, the transmitted lights diffracted at different angles in different in-plane regions can be suitably brighter.

In the PB lens 40PB, as described above, since the angle of diffraction increases as the one period A of the liquid crystal alignment pattern becomes shorter, a larger twist angle in the thickness direction is set for a region with a shorter one period A of the liquid crystal alignment pattern, so that the transmitted light can be brighter. Thus, in the PB lens 40PB, preferably, the regions with different lengths of one period of the liquid crystal alignment pattern include regions where the order of length of one period and the order of twist angle in the thickness direction are different.

The PB lens 40PB preferably includes the optically anisotropic layer 420A formed from a liquid crystal composition containing the liquid crystal molecules 420. The optically anisotropic layer 420A preferably includes regions each of which has a liquid crystal alignment pattern with the orientation of the optic axis of the liquid crystal molecules varying while continuously rotating in at least one in-plane direction, and in which the optic axis is preferably twist-rotated in the thickness direction of the optically anisotropic layer 420A. The twist angle in the thickness direction preferably differs from region to region.

Preferably, the PB lens 40PB includes regions with different lengths of one period in the liquid crystal alignment pattern, where the one period is the length in which the orientation of the optic axis of the liquid crystal molecules 420 is rotated by 1800 in the plane.

Preferably, the optically anisotropic layer 420A includes the regions with different lengths of one period in the liquid crystal alignment pattern arranged by length of one period, and the regions with different twist angles in the thickness direction arranged by twist angle in the thickness direction, wherein the direction of the arrangement by length of one period and the direction of the arrangement by twist angle in the thickness direction are different.

Preferably, the optically anisotropic layer 420A includes regions where the twist angle in the thickness direction is from 10° to 360°.

Preferably, in the optically anisotropic layer 420A, the one period of the liquid crystal alignment pattern becomes shorter gradually in the one direction in which the orientation of the optic axis of the liquid crystal molecules 420 in the liquid crystal alignment pattern varies while continuously rotating.

Preferably, the liquid crystal alignment pattern of the optically anisotropic layer 420A is a concentric circular pattern where the one direction, in which the orientation of the optic axis of the liquid crystal molecules 420 varies while continuously rotating, lies from inside toward outside.

The PB lens 40PB in FIG. 8 is a PB lens with the twist angle varying in the plane, and is an element having a high diffraction efficiency even when the angle of diffraction is large. Yet, the PB lens 40PB may be a PB lens with the twist angle not varying in the plane. Specifically, the PB lens 40PB may be a PB lens without a twist in the thickness direction or with a constant twist angle in the plane. For example, the polarization diffraction grating disclosed in JP 2008-532085 T can be used.

Preferably, the PB lens 40PB is a PB lens including a plurality of optically anisotropic layers 420A, and the optically anisotropic layers 420A are different from one another in orientation of the twist angle in the thickness direction.

Preferably, the PB lens 40PB is a PB lens including a plurality of optically anisotropic layers 420A, and the optically anisotropic layers 420A are different from one another in twist angle in the thickness direction.

Preferably, the PB lens 40PB is a PB lens including a plurality of optically anisotropic layers 420A, and the optically anisotropic layers 420A have liquid crystal alignment patterns that are the same as one another in in-plane direction in which the orientation of the optic axis of the liquid crystal molecules 420 continuously rotates.

Preferably, the length of one period in the liquid crystal alignment pattern is 50 μm or shorter.

### (Circularly Polarized Light-Selective Reflector)

The circularly polarized light-selective reflector 50 selectively reflects circularly polarized light having passed through the PB lens 40PB. Preferably, the circularly polarized light-selective reflector 50 transmits circularly polarized light with the same rotation direction as circularly polarized light having passed through the circular polarizer 20 while reflecting circularly polarized light with the opposite rotation direction from circularly polarized light having passed through the circular polarizer 20. For example, when circularly polarized light having passed through the circular polarizer 20 is circularly polarized light rotating clockwise, the circularly polarized light-selective reflector 50 is configured to transmit circularly polarized light rotating clockwise while reflecting circularly polarized light rotating counterclockwise.

The circularly polarized light-selective reflector 50 may include a laminate of the reflective linearly polarizing plate 51 and the second quarter-wave plate 52. The reflective linearly polarizing plate 51 can be the same polarizing plate as the reflective linearly polarizing plates described as examples of the circular polarizer 20. The second quarter-wave plate 52 can be the same plate as the first quarter-wave plate 22 above. Preferably, the slow axis of the first quarter-wave plate 22 of the circular polarizer 20 and the slow axis of the second quarter-wave plate 52 of the circularly polarized light-selective reflector 50 are orthogonal to each other.

The circularly polarized light-selective reflector 50 may be a cholesteric liquid crystal element. When the circularly polarized light-selective reflector 50 is a cholesteric liquid crystal element, the same one as the cholesteric liquid crystal element described above as an example of the circular polarizer 20 can be used. Light having passed through the cholesteric liquid crystal element is circularly polarized light. When both the circular polarizer 20 and the circularly polarized light-selective reflector 50 are cholesteric liquid crystal elements, preferably, the cholesteric liquid crystal element as the circular polarizer 20 and the cholesteric liquid crystal element as the circularly polarized light-selective reflector 50 are opposite from each other in direction (clockwise, counterclockwise) of the transmitted circularly polarized light.

The circularly polarized light-selective reflector 50 preferably has a planar shape. This configuration can further improve the productivity in terms of reliability and yield. More preferably, the PB lens 40PB side surface of the circularly polarized light-selective reflector 50 has a planar shape.

### Modified Example 1 of Embodiment 1

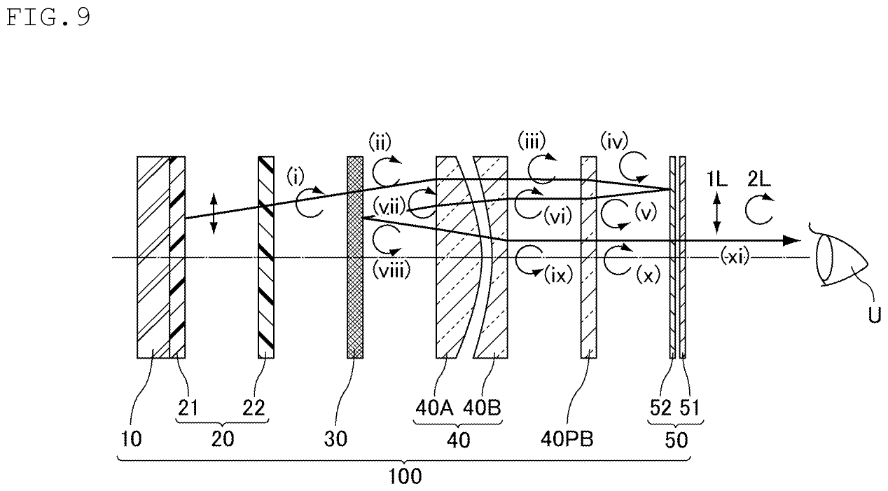

In the present modified example, features unique to the present modified example are mainly described and description of the same features as in Embodiment 1 is omitted. FIG. 9 is an exploded schematic view schematically showing a display device of Modified Example 1 of Embodiment 1. As shown in FIG. 9, the lens 40 of the display device 100 of the present modified example includes a first lens part 40A and a second lens part 40B. This configuration also enables folded optics using the semi-transparent mirror 30, thus making the display device 100 thin. The configuration also can provide the optical power obtainable by making the circularly polarized light-selective reflector 50 side surface of the lens 40 spherical to the PB lens 40PB, thus enhancing the display characteristics of the display device 100 while making the circularly polarized light-selective reflector 50 side surface of the lens 40 planar. In addition, the circularly polarized light-selective reflector 50 side surface of the lens 40 having a planar shape allows easy attachment of the circularly polarized light-selective reflector 50 to the lens 40, improving the productivity. Furthermore, the lens 40 including the first lens part 40A and the second lens part 40B can increase the optical power of the display device 100, further enhancing the display characteristics of the display device 100.

The lens 40 includes the first lens part 40A and the second lens part 40B. The first lens part 40A and the second lens part 40B each may be any lens that enlarges/reduces images on the display panel 10 and may be a refractive lens or a diffractive lens.

### Modified Example 2 of Embodiment 1

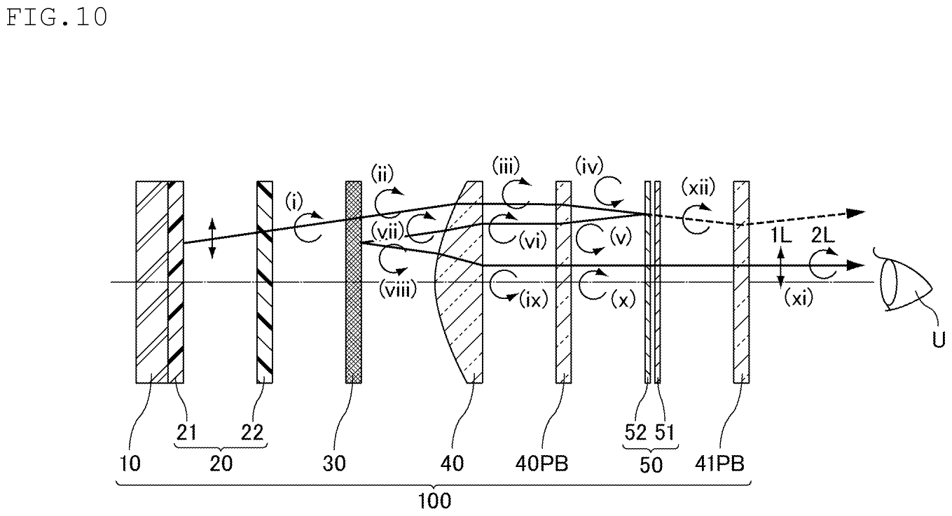

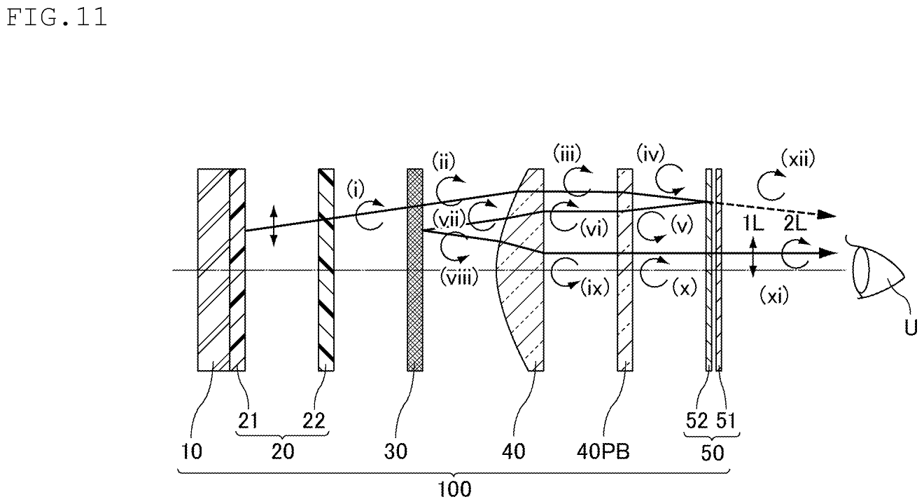

In the present modified example, features unique to the present modified example are mainly described and description of the same features as in Embodiment 1 is omitted. FIG. 10 is an exploded schematic view schematically showing a display device of Modified Example 2 of Embodiment 1. FIG. 11 is an exploded schematic view schematically showing the mechanism of a ghost image that can be generated in the display device of Embodiment 1. As shown in FIG. 10, a display device 100 of the present modified example further includes a viewer-side PB lens 41PB between the circularly polarized light-selective reflector 50 and the viewer U. This configuration also enables folded optics using the semi-transparent mirror 30, thus making the display device 100 thin. The configuration also can provide the optical power obtainable by making the circularly polarized light-selective reflector 50 side surface of the lens 40 spherical to the PB lens 40PB, thus enhancing the display characteristics of the display device 100 while making the circularly polarized light-selective reflector 50 side surface of the lens 40 planar. In addition, the circularly polarized light-selective reflector 50 side surface of the lens 40 having a planar shape allows easy attachment of the circularly polarized light-selective reflector 50 to the lens 40, improving the productivity.

The following effect can also be achieved. Being a diffractive lens, it is difficult for the PB lens to achieve a diffraction efficiency of 100% unless the light source is a short-wavelength, narrow-directional one such as a laser light source. Thus, light not diffracted by the PB lens 40PB in the display device 100 of Embodiment 1 passes through the PB lens 40PB as is with no change in rotation direction and no convergence or divergence ((xii) in FIG. 11). This can possibly generate ghost images.

As to the display device 100 of the present modified example including the viewer-side PB lens 41PB, light not diffracted is not focused onto the eyes of the viewer U ((xii) in FIG. 10). This can reduce perception of ghost images. As described above, with the viewer-side PB lens 41PB placed closer to the viewer U than the PB lens 40PB is, light that has not been diffracted as intended can be made to travel in a direction shifted from the point of focus (focal point) so as not to be perceived by the eyes of the viewer U.

The viewer-side PB lens 41PB and the PB lens 40PB cause circularly polarized light with the same rotation direction to converge. The focal length of the viewer-side PB lens 41PB may not be the same as the focal length of the PB lens 40PB.

### Embodiment 2

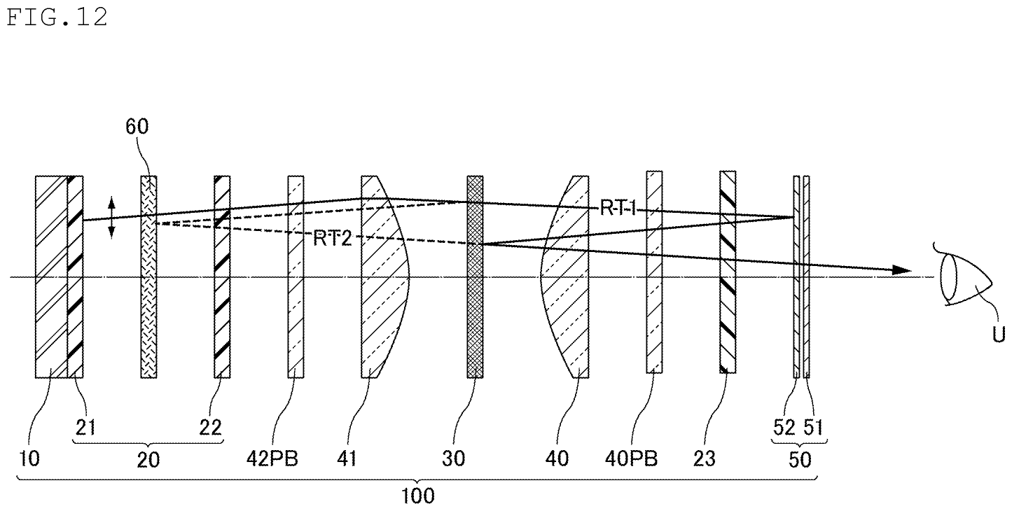

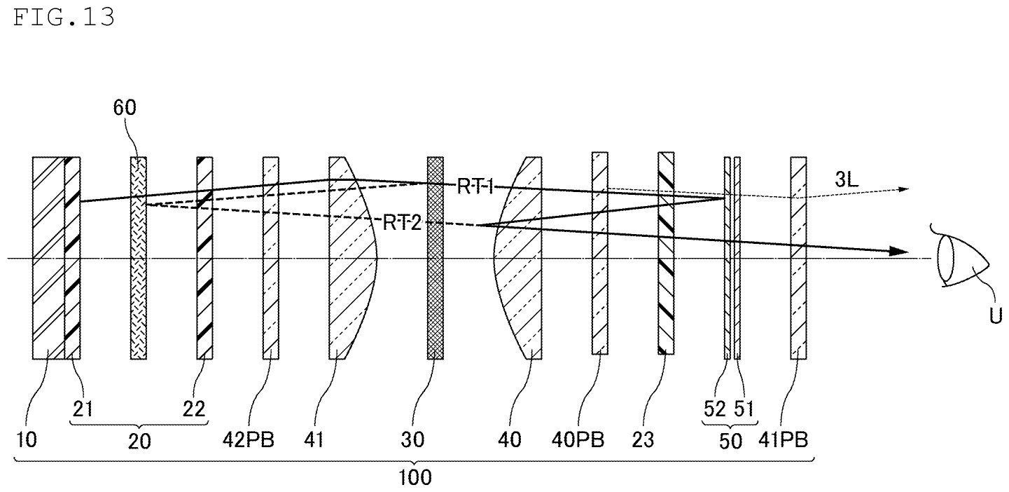

In the present embodiment, features unique to the present embodiment are mainly described and description of the same features as in Embodiment 1 is omitted. FIG. 12 is an exploded schematic view schematically showing a display device of Embodiment 2. As shown in FIG. 12, the lens 40 of Embodiment 1 is a first lens 40, the circularly polarized light-selective reflector 50 of Embodiment 1 is a first circularly polarized light-selective reflector 50, the display device 100 of the present embodiment further includes, between the display panel 10 and the semi-transparent mirror 30, in the following order toward the viewer U, a second circularly polarized light-selective reflector 60, a display panel-side PB lens 42PB, and a second lens 41, a second circularly polarized light-selective reflector 60 side surface of the second lens 41 has a planar shape. This configuration also enables folded optics using the semi-transparent mirror 30, thus making the display device 100 thin. The configuration also can provide the optical power obtainable by making the first circularly polarized light-selective reflector 50 side surface of the first lens 40 spherical to the PB lens 40PB, thus enhancing the display characteristics of the display device 100 while making the first circularly polarized light-selective reflector 50 side surface of the first lens 40 planar. In addition, the first circularly polarized light-selective reflector 50 side surface of the first lens 40 having a planar shape allows easy attachment of the first circularly polarized light-selective reflector 50 to the first lens 40, improving the productivity.

The configuration also can provide the optical power obtainable by making the second circularly polarized light-selective reflector 60 side surface of the second lens 41 spherical to the display panel-side PB lens 42PB, thus enhancing the display characteristics of the display device 100 while making the second circularly polarized light-selective reflector 60 side surface of the second lens 41 planar. In addition, the second circularly polarized light-selective reflector 60 side surface of the second lens 41 having a planar shape allows easy attachment of the second circularly polarized light-selective reflector 60 to the second lens 41, improving the productivity.

Moreover, light traveling along the second path RT2 can be used in addition to light traveling along the first path RT1 corresponding to the pancake lens optics shown in Embodiment 1, so that the light use efficiency can be increased.

Since the image formed using light traveling along the first path RT1 and the image formed using light traveling along the second path RT2 need to be superimposed with each other, the display device 100 preferably essentially has a symmetric structure about the semi-transparent mirror 30.

The display device 100 of the present embodiment specifically includes, in the following order toward the viewer U, the display panel 10, the first linearly polarizing plate 21, the second circularly polarized light-selective reflector 60, the first quarter-wave plate 22, the display panel-side PB lens 42PB, the second lens 41, the semi-transparent mirror 30, the first lens 40, the PB lens 40PB, the second quarter-wave plate 23, and the first circularly polarized light-selective reflector 50.

The second circularly polarized light-selective reflector 60 side surface of the second lens 41 has a planar shape. The second lens 41 is the same as the first lens 40, except that the second circularly polarized light-selective reflector 60 side surface has a planar shape.

The display panel-side PB lens 42PB is the same as the PB lens 40PB.

The second circularly polarized light-selective reflector 60 is the same as the first circularly polarized light-selective reflector 50. The second circularly polarized light-selective reflector 60 is preferably disposed between the first linearly polarizing plate 21 and the first quarter-wave plate 22.

The second quarter-wave plate 23 is the same as the first quarter-wave plate 22. Preferably, the slow axis of the first quarter-wave plate 22 and the slow axis of the second quarter-wave plate 23 are orthogonal to each other. Herein, two straight lines (including axes, directions, and azimuths) being orthogonal to each other means that the angle (absolute value) formed between them falls within the range of 90° 3°, preferably within the range of 90°±1°, more preferably within the range of 90° 0.5°, particularly preferably 90° (perfectly orthogonal). Also herein, two straight lines (including axes, directions, and azimuths) being parallel to each other means that the angle (absolute value) between them falls within the range of 0°±3°, preferably within the range of 0°±1°, more preferably within the range of 0°±0.5°, particularly preferably 0° (perfectly parallel).

### Modified Example 1 of Embodiment 2

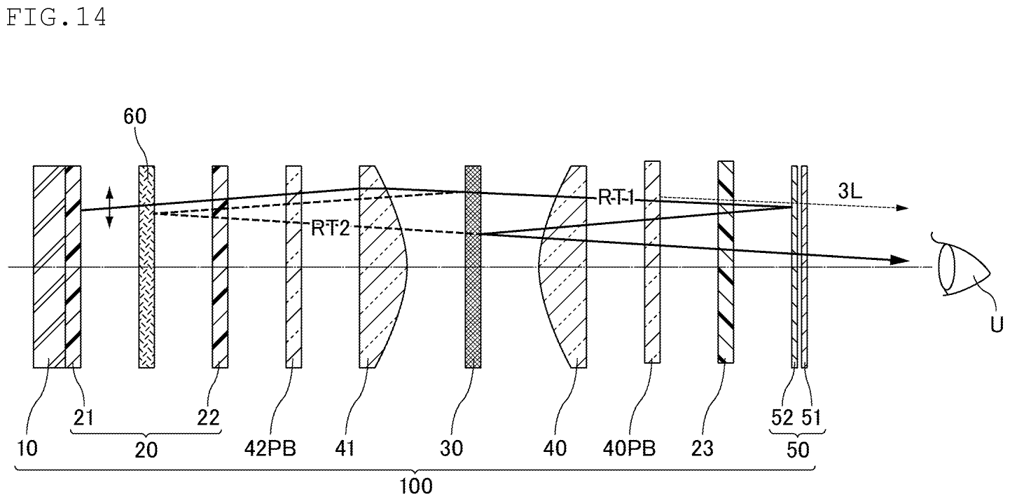

In the present modified example, features unique to the present modified example are mainly described and description of the same features as in Embodiment 2 is omitted. FIG. 13 is an exploded schematic view schematically showing a display device of Modified Example 1 of Embodiment 2. FIG. 14 is an exploded schematic view schematically showing the mechanism of a ghost image that can be generated in the display device of Embodiment 2. As shown in FIG. 13, a display device 100 of the present modified example further includes, between the first circularly polarized light-selective reflector 50 and the viewer U, a viewer-side PB lens 41PB. This configuration also enables folded optics using the semi-transparent mirror 30, thus making the display device 100 thin. The configuration also can provide the optical power obtainable by making the first circularly polarized light-selective reflector 50 side surface of the first lens 40 spherical to the PB lens 40PB, thus enhancing the display characteristics of the display device 100 while making the first circularly polarized light-selective reflector 50 side surface of the first lens 40 planar. In addition, the first circularly polarized light-selective reflector 50 side surface of the first lens 40 having a planar shape allows easy attachment of the first circularly polarized light-selective reflector 50 to the first lens 40, improving the productivity.

The configuration also can provide the optical power obtainable by making the second circularly polarized light-selective reflector 60 side surface of the second lens 41 spherical to the display panel-side PB lens 42PB, thus enhancing the display characteristics of the display device 100 while making the second circularly polarized light-selective reflector 60 side surface of the second lens 41 planar. In addition, the second circularly polarized light-selective reflector 60 side surface of the second lens 41 having a planar shape allows easy attachment of the second circularly polarized light-selective reflector 60 to the second lens 41, improving the productivity.

Moreover, light traveling along the second path RT2 can be used in addition to light traveling along the first path RT1 corresponding to the pancake lens optics shown in Embodiment 1, so that the light use efficiency can be increased.

The following effect can also be achieved. Being a diffractive lens, it is difficult for the PB lens to achieve a diffraction efficiency of 100% unless the light source is a short-wavelength, narrow-directional one such as a laser light source. Thus, light not diffracted by the PB lens 40PB in the display device 100 of Embodiment 2 passes through the PB lens 40PB as is with no change in rotation direction and no convergence or divergence (light 3L in FIG. 14). This can possibly generate ghost images.

As to the display device 100 of the present modified example including the viewer-side PB lens 41PB, light not diffracted is not focused onto the eyes of the viewer U (light 3L in FIG. 13). This can reduce perception of ghost images. As described above, with the viewer-side PB lens 41PB placed closer to the viewer U than the PB lens 40PB is, light that has not been diffracted as intended can be made to travel in a direction shifted from the point of focus (focal point) so as not to be perceived by the eyes of the viewer U.

### Embodiment 3

In the present modified example, features unique to the present modified example are mainly described and description of the same features as in Embodiment 1 and modified examples thereof and Embodiment 2 and modified examples thereof is omitted. A display device of the present embodiment includes a liquid crystal panel as the display panel. In the present embodiment, a display panel is a liquid crystal panel including a pair of substrates and a liquid crystal layer sandwiched between the pair of substrates, a circular polarizer includes a laminate of a first linearly polarizing plate and a quarter-wave plate, and a second linearly polarizing plate is further provided to face the circular polarizer across the display panel. Description of the same configuration as in Embodiment 1 is omitted.

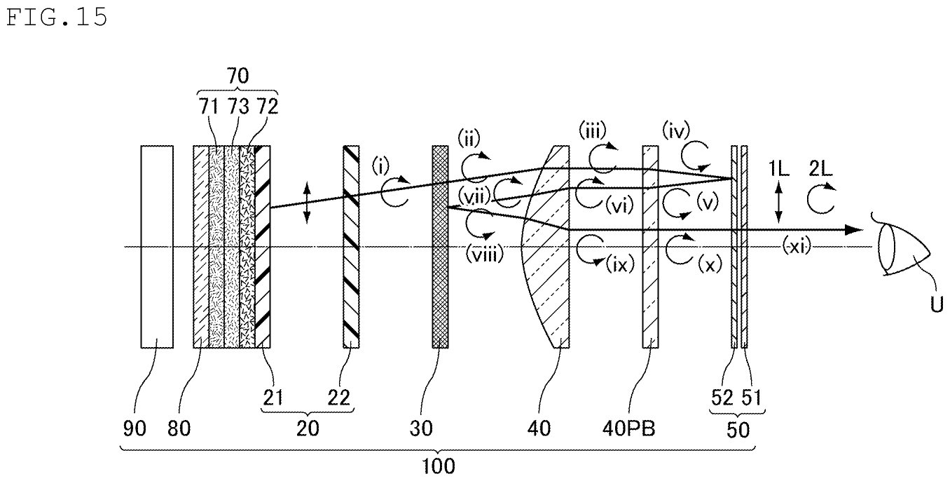

FIG. 15 is an exploded cross-sectional view schematically showing a display device of Embodiment 3. As shown in FIG. 15, in the display device 100 of the present embodiment, a display panel (liquid crystal panel) 70 includes a pair of substrates 71 and 72 and a liquid crystal layer 73 sandwiched between the pair of substrates 71 and 72. The substrate 71 may be a TFT substrate 71. The substrate 72 may be a counter substrate 72.

The TFT substrate 71 may be, as shown in Embodiment 1, a TFT substrate including, on a supporting substrate, gate lines extending parallel to one another, source lines extending parallel to one another in a direction in which they intersect the gate lines via a gate insulator, and TFTs disposed at or near the respective intersections of the gate lines and the source lines.

The display mode of the liquid crystal panel is not limited. The liquid crystal panel may be in a horizontal alignment (transverse electric field) mode in which the counter electrode is disposed in the TFT substrate 71, or may be in a vertical alignment (vertical electric field) mode in which the counter electrode is disposed in the counter substrate 72 facing the TFT substrate 71 across the liquid crystal layer 73.

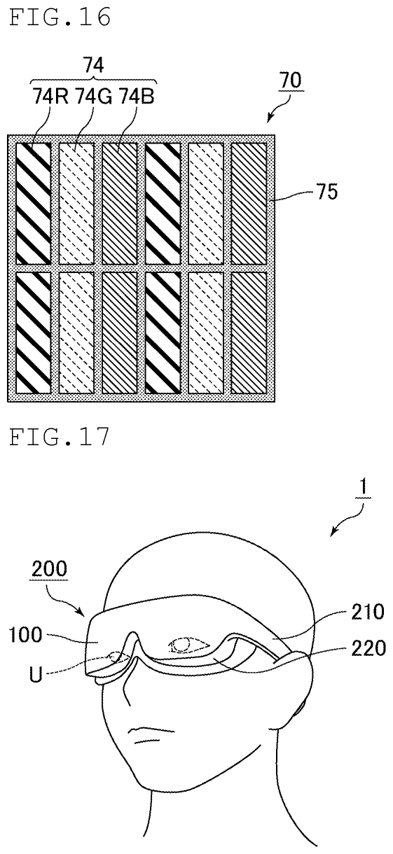

FIG. 16 is a schematic plan view of the liquid crystal panel shown in FIG. 15. The counter substrate 72 may be a color filter (CF) substrate including a supporting substrate and a black matrix and a CF layer which are formed on the supporting substrate.

As shown in FIG. 16, the CF substrate may have a configuration in which, for example, color filters 74 are arranged in the plane and partitioned by a black matrix 75. The color filters 74 may include red color filters 74R, green color filters 74G, and blue color filters 74B. The color filters 74 may be in a stripe arrangement where red, green, and blue color filters are repeated in the row direction and the color filters 74R, 74G, and 74B are arranged by color in the column directions. Pixels overlapping the red, green, and blue color filters 74R, 74G, and 74B respectively define red, blue, and green pixels.

The black matrix 75 can be one usually used in the field of liquid crystal panels and may be formed from a resin containing a black pigment, for example. The black matrix 75 may be in a grid pattern that overlaps the gate lines and/or source lines in a plan view.

The liquid crystal layer 73 includes liquid crystal molecules. In response to voltage applied between the common electrode and the pixel electrodes, an electric field is generated in the liquid crystal layer 73, and the alignment of the liquid crystal molecules varies according to the electric field, so that the amount of light transmitted can be controlled. The alignment azimuth of the liquid crystal molecules with no voltage applied is controlled by the controlling force of the alignment films. The state with no voltage applied means a state where no voltage is applied between the pair of electrodes (to the liquid crystal layer 73) or voltage lower than the threshold for the liquid crystal molecules is applied between the electrodes (to the liquid crystal layer 73).

The anisotropy of dielectric constant (Δε) of the liquid crystal molecules defined by the following formula may be positive or negative.

Δε=(dielectric constant in long axis direction)−(dielectric constant in short axis direction)

An alignment film may be disposed between the TFT substrate 71 and the liquid crystal layer 73 and an alignment film may be disposed between the counter substrate 72 and the liquid crystal layer 73. With no voltage applied to the liquid crystal layer 73, the alignment of liquid crystal molecules is controlled mainly by the force of the alignment films. For example, in a horizontal alignment mode, the tilt angle (pre-tilt angle) of liquid crystal molecules with no voltage applied may be from 0° to 5°, preferably from 0° to 3°, more preferably from 0° to 1°. The tilt angle of liquid crystal molecules means an angle at which the long axis direction (optic axis) of the liquid crystal molecules tilts toward the surface of the TFT substrate 71 or the surface of the counter substrate 72.

The second linearly polarizing plate 80 faces the circular polarizer 20 across the liquid crystal panel 70 (faces the viewer U across the liquid crystal panel 70). Preferably, the transmission axis of the first linearly polarizing plate 21 and the transmission axis of the second linearly polarizing plate 80 are disposed orthogonal to each other, i.e., in crossed Nicols. The second linearly polarizing plate 80 can be the same one as the first linearly polarizing plate 21.

The case of the normally black mode is described as an example. With no voltage applied, the alignment azimuth of liquid crystal molecules in a plan view is substantially parallel to the transmission axis of the first linearly polarizing plate 21 or the second linearly polarizing plate 80. Light incident on the back surface of the liquid crystal panel passes through the second linearly polarizing plate 80 to be linearly polarized light. The linearly polarized light passes through the liquid crystal layer 73 but does not pass through the first linearly polarizing plate 21, so that the liquid crystal panel provides black display. Meanwhile, when voltage is applied to the liquid crystal layer 73, the alignment azimuth of liquid crystal molecules changes from the initial alignment azimuth, whereby the long axis direction of the liquid crystal molecules forms an angle with the transmission axes of the first linearly polarizing plate 21 and the second linearly polarizing plate 80. Thus, light passes through the first linearly polarizing plate 21, so that the liquid crystal panel provides white display.

In the present embodiment, linearly polarized light having passed through the first linearly polarizing plate 21 passes through the quarter-wave plate 22 to be converted to circularly polarized light. When the circular polarizer is the cholesteric liquid crystal element described above, the display quality of the liquid crystal panel may deteriorate because light reflected by the cholesteric liquid crystal element becomes stray light, which is a factor of unclear video. Thus, in the present embodiment where the display panel 10 used is a liquid crystal panel, preferably, the circular polarizer used is a laminate of the first linearly polarizing plate 21 and the quarter-wave plate 22.

### (Backlight)

The display device 100 of the present embodiment may further include a backlight that includes a light source and faces the liquid crystal panel 70 across the second linearly polarizing plate 80.

The backlight may be a direct-lit backlight or an edge-lit backlight. The direct-lit backlight includes a light source disposed on or behind the back surface of the liquid crystal panel. The edge-lit backlight includes a light guide plate disposed on or behind the back surface of the liquid crystal panel and a light source disposed at the side edge of the light guide plate. The edge-lit backlight utilizes the light source to illuminate the side edge of the light guide plate and utilizes the light guide plate to emit light toward the liquid crystal panel. A reflective sheet may be disposed on or behind the back surface of the light guide plate, and a prism sheet or a diffusing sheet, for example, may be disposed between the light guide plate and the display device 100.

The backlight preferably causes light emitted from the light source to converge in the direction along the thickness of the liquid crystal panel. The backlight may have a full width at half maximum of from 15° to 30°. The full width at half maximum can be defined by measuring the luminance viewing angle characteristics by a method in conformity with IEC 61747-30 and determining the range of angle in which the luminance is equal to or more than half of the maximum luminance.

### Embodiment 4

In the present embodiment, features unique to the present embodiment are mainly described and description of the same features as in Embodiment 1 is omitted. FIG. 17 is a schematic perspective view showing an example of the appearance of a head-mounted display of Embodiment 4. As shown in FIG. 17, a head-mounted display 200 of the present embodiment includes a display device 100 and a wearable part 210 to be worn on the head of a viewer U. The head-mounted display 200 of the present embodiment may be an immersive HMD that surrounds the space in front of the eyes of the viewer U to shield the space from external light when worn on the head, or may be an eyeglass-type HMD.

The display device 100 has a function of displaying a video (images) to the viewer U. The display device 100 converts video display signals to a video.

When the head-mounted display 200 is an eyeglass-type HMD, as shown in FIG. 17, the portions corresponding to lenses of glasses may be defined by the display device 100, and the wearable part 210 may be the temples of glasses that sit on the ears of the viewer U.

When the head-mounted display 200 is an immersive HMD, the wearable part 210 may include a fitting band that surrounds the head when worn by the viewer U and fixes the head-mounted display 200 on the head of the viewer U.

The head-mounted display 200 may employ a one-display system using one display panel for both eyes, or a two-display system using one display panel for each eye. The immersive HMD described above is applicable to both the one-display system and the two-display system, for example. The eyeglass-type HMD is applicable to the two-display system, for example.

The head-mounted display 200 may further include a facial cushion 220 disposed between the display device 100 and the face of the viewer U. The facial cushion 220 is a cushioning material disposed between the display device 100 and the face of the viewer U. With the facial cushion 220, external light entering the field of view of the viewer U can be reduced while the head-mounted display 200 is used.

The head-mounted display 200 may further include a sound output unit that has a function of generating voice, music, sound effects, and other sounds.

The sound output unit converts sound output signals to sounds. Usually, products available as headphones can be used. The sound output unit, together with the wearable part 210, may function as a contact part that comes into contact with the ear when the head-mounted display 200 is worn on the head of the viewer U.

The head-mounted display 200 may include a driving unit that outputs video display signals and sound output signals. The driving unit is wired or wirelessly connected to the display device 100 and the sound output unit. The wireless communication system may be, for example, Bluetooth®.

### EXAMPLE

The present invention is described below with reference to examples and comparative examples. The present invention is not limited to these examples.

### Comparative Example 1

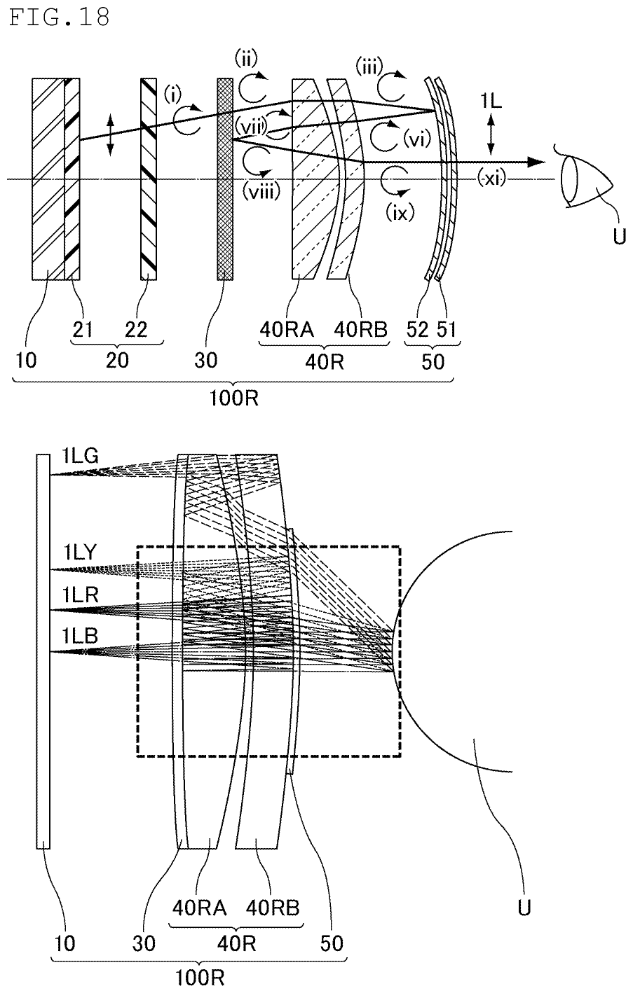

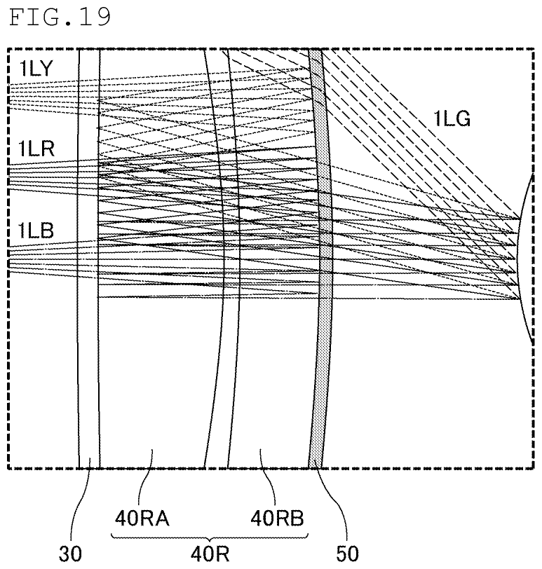

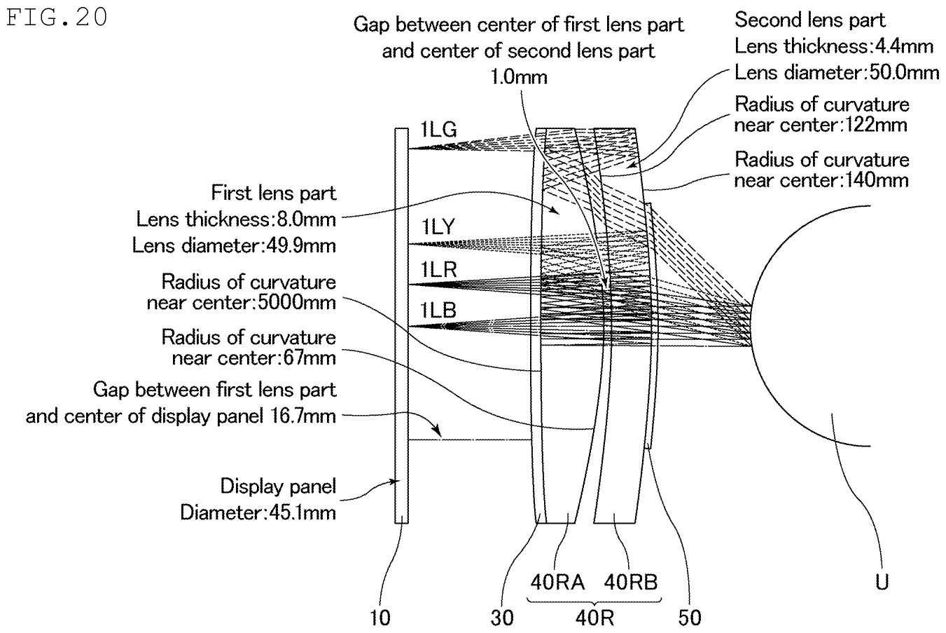

A display device 100R of Comparative Example 1 corresponding to the comparative embodiment above was used to perform a simulation with optical design software to find if a surface to which a circularly polarized light-selective reflector 50 is attached is planar. FIG. 18 includes an exploded schematic view schematically showing a display device of Comparative Example 1 and a simulation view. FIG. 19 is an enlarged view of the region surrounded by the dashed line in FIG. 18. FIG. 20 is a view showing the detailed simulation results of the display device of Comparative Example 1. FIG. 18 to FIG. 20 show light 1LR, light 1LY, light 1LG, and light 1LB which enter the eye at different angles Y. The light 1LR enters the eye at angle Y of 10°. The light 1LY enters the eye at an angle Y of 20°. The light 1LG enters the eye at an angle Y of 45°. The light 1LB enters the eye at an angle Y of 0°. The paths of the light 1LR, the light 1LY, the light 1LG, and the light 1LB were determined by the simulation. The angle Y at which light enters the eye is determined as an angle from the reference angle (0°) which corresponds to the horizontal direction when a viewer U sees the display device 100 directly in front of the viewer U. In other words, the angle Y at which light enters the eye is an angle formed between the horizontal direction when the viewer U sees the display device 100 directly in front of the viewer U and the light entering the eye of the viewer U.

As shown in FIG. 18, a lens 40R in the display device 100R of Comparative Example 1 included a first lens part 40RA on its display panel 10 side and a second lens part 40RB on its circularly polarized light-selective reflector 50 side. Here, the first lens part 40RA and the second lens part 40RB were the same as the first lens part 40A and the second lens part 40B, respectively. Basically, a simulation is ideally performed using a lens 40R consisting of a single lens part. In the present comparative example, however, in order to further increase the optical power, a simulation was performed using the lens 40R including the first lens part 40RA and the second lens part 40RB.

A first linearly polarizing plate 21 and a first quarter-wave plate 22 in the display device 100R of Comparative Example 1 were attached to the display panel 10, but are omitted from the lower part of FIG. 18 and from FIG. 20. Also, a semi-transparent mirror 30 was attached to the left surface (display panel 10 side surface) of the left side (display panel 10 side) lens part (first lens part 40RA) of the two lens parts (first lens part 40RA and second lens part 40RB) in the lens 40R. In addition, a circularly polarized light-selective reflector 50 was attached to the right surface (circularly polarized light-selective reflector 50 side surface) of the right side (circularly polarized light-selective reflector 50 side) lens part (second lens part 40RB) of the two lens parts (first lens part 40RA and second lens part 40RB) in the lens 40R.

The simulation results found that, as shown in FIG. 20, the display panel 10 had a diameter of 45.1 mm. The gap between the center of the first lens part 40RA and the center of the second lens part 40RB was 1.0 mm. The gap between the first lens part 40RA and the center of the display panel 10 was 16.7 mm.

The first lens part 40RA had a thickness of 8.0 mm and a diameter of 49.9 mm. The first lens part 40RA had a radius of curvature of 5000 mm near the center of its display panel 10 side surface. The first lens part 40RA had a radius of curvature of 67 mm near the center of its circularly polarized light-selective reflector 50 side surface.

The second lens part 40RB had a thickness of 4.4 mm and a diameter of 50.0 mm. The second lens part 40RB had a radius of curvature of 122 mm near the center of its display panel 10 side surface. The second lens part 40RB had a radius of curvature of 140 mm near the center of its circularly polarized light-selective reflector 50 side surface. In other words, in Comparative Example 1, the surface to which the circularly polarized light-selective reflector 50 was to be attached (specifically, the circularly polarized light-selective reflector 50 side surface of the lens 40R) needed to be spherical.

As described above, in the display device 100R of Comparative Example 1, the lens surface closest to the circularly polarized light-selective reflector 50 (circularly polarized light-selective reflector 50 side lens surface of the second lens part 40RB) was required to have a radius of curvature of 140 mm at the center and have a spherical shape. Thus, the circularly polarized light-selective reflector 50 is presumed to be difficult to attach to the lens 40R.

### Example 1

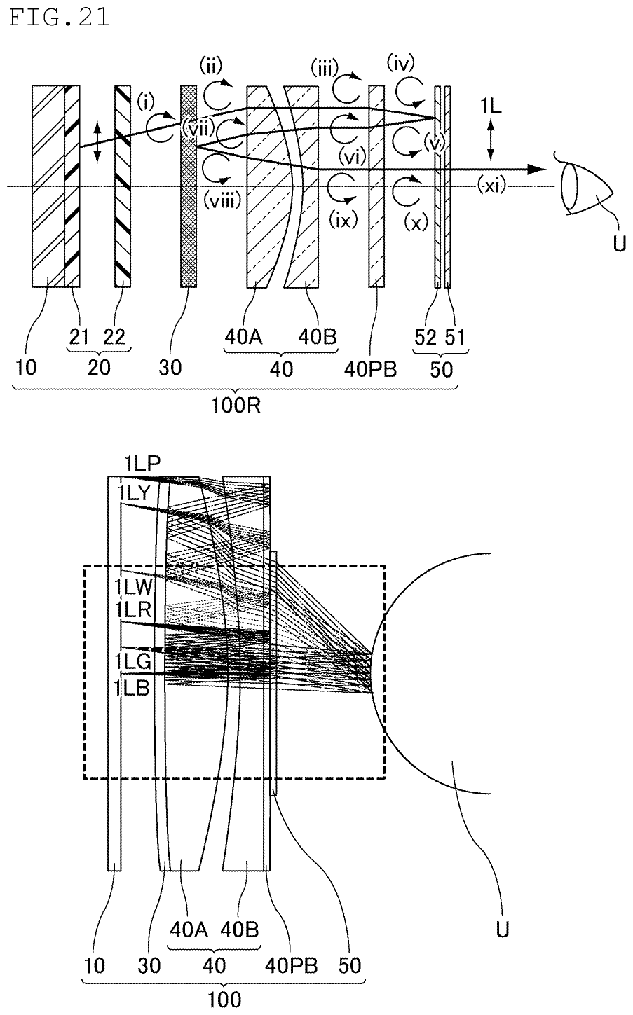

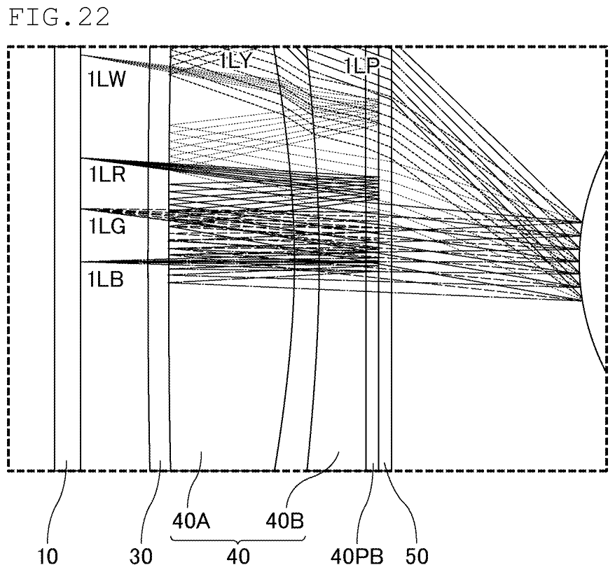

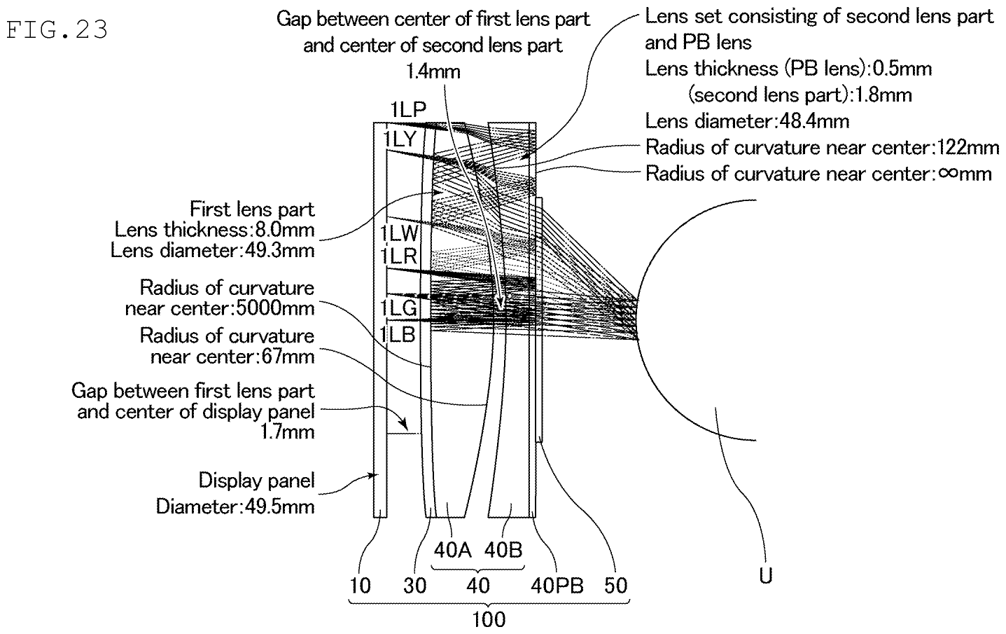

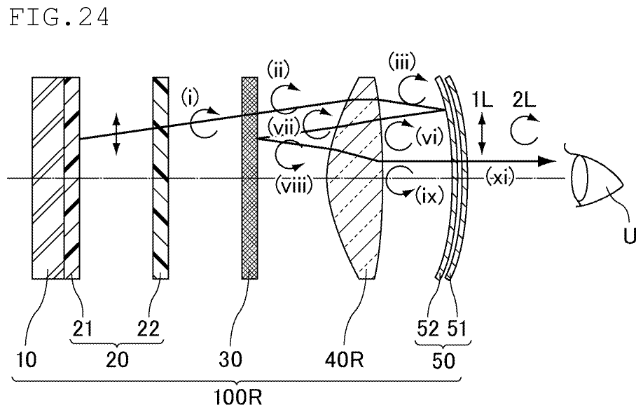

A display device 100 of Example 1 corresponding to Modified Example 1 of Embodiment 1 was used to perform a simulation with optical design software by the same procedure as in Comparative Example 1 to find if a surface to which a circularly polarized light-selective reflector 50 is attached is planar. FIG. 21 includes an exploded schematic view schematically showing a display device of Example 1 and a simulation view. FIG. 22 is an enlarged view of the region surrounded by the dashed line in FIG. 21. FIG. 23 is a view showing the detailed simulation results of the display device of Example 1. FIG. 21 to FIG. 23 show light 1LR, light 1LY, light 1LG, light 1LB, light 1LP, and light 1LW which enter the eye at different angles Y. The light 1LR enters the eye at angle Y of 10°. The light 1LY enters the eye at an angle Y of 35°. The light 1LG enters the eye at an angle Y of 5°. The light 1LB enters the eye at an angle Y of 0°. The light 1LP enters the eye at an angle Y of 45°. The light 1LW enters the eye at an angle Y of 20°. The paths of the light 1LR, the light 1LY, the light 1LG, the light 1LB, the light 1LP, and the light 1LW were determined by the simulation.

As shown in FIG. 21, a lens 40 in the display device 100 of Example 1 included a first lens part 40A on its display panel 10 side and a second lens part 40B on its circularly polarized light-selective reflector 50 side. Basically, a simulation is ideally performed using a lens 40 consisting of a single lens part. In the present example, however, in order to further increase the optical power, a simulation was performed using the lens 40 including the first lens part 40A and the second lens part 40B.

A first linearly polarizing plate 21 and a first quarter-wave plate 22 in the display device 100 of Example 1 were attached to the display panel 10, but are omitted from the lower part of FIG. 21 and from FIG. 22 and FIG. 23. Also, a semi-transparent mirror 30 was attached to the left surface (display panel 10 side surface) of the left side (display panel 10 side) lens part (first lens part 40A) of the two lens parts (first lens part 40A and second lens part 40B) in the lens 40. In addition, a circularly polarized light-selective reflector 50 was attached to the right surface (circularly polarized light-selective reflector 50 side surface) of the right side (circularly polarized light-selective reflector 50 side) lens part (second lens part 40B) of the two lens parts (first lens part 40A and second lens part 40B) in the lens 40.

The simulation results found that, as shown in FIG. 23, the display panel 10 had a diameter of 49.5 mm. The gap between the center of the first lens part 40A and the center of the second lens part 40B was 1.4 mm. The gap between the first lens part 40A and the center of the display panel 10 was 1.7 mm.

The first lens part 40A had a thickness of 8.0 mm and a diameter of 49.3 mm. The first lens part 40A had a radius of curvature of 5000 mm near the center of its display panel 10 side surface. The first lens part 40A had a radius of curvature of 67 mm near the center of its circularly polarized light-selective reflector 50 side surface.

The second lens part 40B had a thickness of 1.8 mm and the PB lens 40PB had a thickness of 0.5 mm. The lens set consisting of the second lens part 40B and the PB lens 40PB had a diameter of 48.4 mm. The lens set had a radius of curvature of 122 mm near the center of its display panel 10 side surface. The lens set had a radius of curvature of ∞ mm near the center of its circularly polarized light-selective reflector 50 side surface. In other words, in Example 1, the circularly polarized light-selective reflector 50 side lens shape of the lens set consisting of the second lens part 40B and the PB lens 40PB was found to be planar. Since the main surface of the PB lens 40PB is planar, the circularly polarized light-selective reflector 50 side surface of the lens 40 (specifically, second lens part 40B) is considered planar. Thus, in Example 1, the surface to which the circularly polarized light-selective reflector 50 was to be attached (specifically, the circularly polarized light-selective reflector 50 side surface of the lens 40) was found to be planar.

As described above, in Example 1 using the PB lens 40PB, substantially the same characteristics as those in Comparative Example 1 were achieved while the lens surface closest to the circularly polarized light-selective reflector 50 (circularly polarized light-selective reflector 50 side lens surface of the lens set, specifically the circularly polarized light-selective reflector 50 side lens surface of the lens 40) was successfully made planar. In other words, with the PB lens 40PB disposed between the lens 40 and the circularly polarized light-selective reflector 50, the lens surface to which the circularly polarized light-selective reflector 50 is to be attached can be made planar, not spherical, so that the circularly polarized light-selective reflector 50 can be easily attached to the lens 40 and thus the productivity can be improved.

The display device 100 of the present example uses folded optics including the semi-transparent mirror 30, and thus the display device 100 was successfully made thin. This configuration also can provide the optical power obtainable by making the circularly polarized light-selective reflector 50 side surface of the lens 40 spherical to the PB lens 40PB, thus successfully enhancing the display characteristics of the display device 100 while making the circularly polarized light-selective reflector 50 side surface of the lens 40 planar.

### Example 2

A display device of the present example corresponds to the display device 100 of Embodiment 1. Similar to Example 1, the display device 100 of the present example uses folded optics including the semi-transparent mirror 30, and thus the display device 100 can be made thin. This configuration also can provide the optical power obtainable by making the circularly polarized light-selective reflector 50 side surface of the lens 40 spherical to the PB lens 40PB, thus enhancing the display characteristics of the display device 100 while making the circularly polarized light-selective reflector 50 side surface of the lens 40 planar. In addition, presumably, the circularly polarized light-selective reflector 50 side surface of the lens 40 having a planar shape allows easy attachment of the circularly polarized light-selective reflector 50 to the lens 40, improving the productivity.

In the display device 100 of the present example, however, ghost images may be perceived in some cases. Being a diffractive lens, it is difficult for the PB lens to achieve a diffraction efficiency of 100% for all lights (oblique incident light, the entire visible spectrum). For example, as shown by (xii) in FIG. 11, light not diffracted by the PB lens 40PB in some cases passes through the PB lens 40PB as is with no convergence or divergence and no conversion of circularly polarized light to opposite-handed circularly polarized light. This can presumably generate ghost images.

### Example 3

A display device of the present example corresponds to the display device 100 of Modified Example 2 of Embodiment 1. Similar to Example 1, the display device 100 of the present example uses folded optics including the semi-transparent mirror 30, and thus the display device 100 can be made thin. This configuration also can provide the optical power obtainable by making the circularly polarized light-selective reflector 50 side surface of the lens 40 spherical to the PB lens 40PB, thus enhancing the display characteristics of the display device 100 while making the circularly polarized light-selective reflector 50 side surface of the lens 40 planar. In addition, presumably, the circularly polarized light-selective reflector 50 side surface of the lens 40 having a planar shape allows easy attachment of the circularly polarized light-selective reflector 50 to the lens 40, improving the productivity.

In the present example, perception of ghost images can be reduced or prevented. Here, light that has not been diffracted by the PB lens 40PB is in a polarization state different from the intended state, and thus unintentionally passes through the circularly polarized light-selective reflector 50. Yet, the display device 100 of the present example includes the viewer-side PB lens 41PB between the circularly polarized light-selective reflector 50 and the viewer U. This presumably causes light traveling along the correct path to focus on the eyes of the viewer U, while causing light inducing ghost images not to focus on the eyes of the viewer U, thus reducing or preventing perception of ghost images.

### Example 4

A display device of the present example corresponds to the display device 100 of Embodiment 2. Similar to Example 1, the display device 100 of the present example uses folded optics including the semi-transparent mirror 30, and thus the display device 100 can be made thin. This configuration also can provide the optical power obtainable by making the first circularly polarized light-selective reflector 50 side surface of the first lens 40 spherical to the PB lens 40PB, thus enhancing the display characteristics of the display device 100 while making the first circularly polarized light-selective reflector 50 side surface of the first lens 40 planar. In addition, presumably, the first circularly polarized light-selective reflector 50 side surface of the first lens 40 having a planar shape allows easy attachment of the first circularly polarized light-selective reflector 50 to the first lens 40, improving the productivity.

The configuration also can provide the optical power obtainable by making the second circularly polarized light-selective reflector 60 side surface of the second lens 41 spherical to the display panel-side PB lens 42PB, thus enhancing the display characteristics of the display device 100 while making the second circularly polarized light-selective reflector 60 side surface of the second lens 41 planar. In addition, the second circularly polarized light-selective reflector 60 side surface of the second lens 41 having a planar shape allows easy attachment of the second circularly polarized light-selective reflector 60 to the second lens 41, improving the productivity.

Moreover, as shown in FIG. 12, light traveling along the second path RT2 can be used in addition to light traveling along the first path RT1, so that the light use efficiency can be increased.

### Example 5

A display device of the present example corresponds to the display device 100 of Modified Example 1 of Embodiment 2. Similar to Example 4, the display device 100 of the present example uses folded optics including the semi-transparent mirror 30, and thus the display device 100 can be made thin. This configuration also can provide the optical power obtainable by making the first circularly polarized light-selective reflector 50 side surface of the first lens 40 spherical to the PB lens 40PB, thus enhancing the display characteristics of the display device 100 while making the first circularly polarized light-selective reflector 50 side surface of the first lens 40 planar. In addition, presumably, the first circularly polarized light-selective reflector 50 side surface of the first lens 40 having a planar shape allows easy attachment of the first circularly polarized light-selective reflector 50 to the first lens 40, improving the productivity.

The configuration also can provide the optical power obtainable by making the second circularly polarized light-selective reflector 60 side surface of the second lens 41 spherical to the display panel-side PB lens 42PB, thus enhancing the display characteristics of the display device 100 while making the second circularly polarized light-selective reflector 60 side surface of the second lens 41 planar. In addition, the second circularly polarized light-selective reflector 60 side surface of the second lens 41 having a planar shape allows easy attachment of the second circularly polarized light-selective reflector 60 to the second lens 41, improving the productivity.

Moreover, as shown in FIG. 12, light traveling along the second path RT2 can be used in addition to light traveling along the first path RT1, so that the light use efficiency can be increased.

In the present example, perception of ghost images can be reduced or prevented. Here, light that has not been diffracted by the PB lens 40PB is in a polarization state different from the intended state, and thus unintentionally passes through the circularly polarized light-selective reflector 50. Yet, the display device 100 of the present example includes the viewer-side PB lens 41PB between the circularly polarized light-selective reflector 50 and the viewer U. This presumably causes light traveling along the correct path to focus on the eyes of the viewer U, while causing light inducing ghost images not to focus on the eyes of the viewer U, thus reducing or preventing perception of ghost images.

### REFERENCE SIGNS LIST

1L: linearly polarized light
1LB, 1LG, 1LP, 1LR, 1LW, 1LY: light
2L, 3L: circularly polarized light
10: display panel (self-luminous panel)
20: circular polarizer
21, 80: linearly polarizing plate
22, 23, 52: quarter-wave plate
30: semi-transparent mirror
40, 41: lens
40A, 40B: lens part
40PB: Pancharatnam-Berry lens (PB lens)
41PB: viewer-side PB lens
42PB: display panel-side PB lens
50, 60: circularly polarized light-selective reflector
51: reflective linearly polarizing plate
70: display panel (liquid crystal panel)
71: substrate (TFT substrate)
72: substrate (counter substrate)
73: liquid crystal layer
74: color filter
75: black matrix
74B: blue color filter
74G: green color filter
74R: red color filter
100, 100R: display device
200: head-mounted display
210: wearable part
220: facial cushion
410: supporting substrate
420: liquid crystal molecule
420A: optically anisotropic layer
420X: long axis
LC0, LC1, LC2: left-handed circularly polarized light
   R0, R1, R2: region
RT1, RT2: path
   U: viewer

What is claimed is:

1. A display device comprising, in the following order toward a viewer:
a display panel;
a semi-transparent mirror;
a lens;
a Pancharatnam-Berry lens configured to cause one-handed circularly polarized light incident thereon that is left-handed circularly polarized light or right-handed circularly polarized light to converge while causing opposite-handed circularly polarized light incident thereon to diverge; and
a circularly polarized light-selective reflector,
a circularly polarized light-selective reflector side surface of the lens having a planar shape.

2. The display device according to claim 1,
wherein the lens comprises a first lens part and a second lens part.

3. The display device according to claim 1,
wherein the lens is a first lens,
the circularly polarized light-selective reflector is a first circularly polarized light-selective reflector,
the display device further comprises, between the display panel and the semi-transparent mirror, in the following order toward the viewer:
a second circularly polarized light-selective reflector;
a display panel-side Pancharatnam-Berry lens; and
a second lens, and
a second circularly polarized light-selective reflector side surface of the second lens has a planar shape.

4. The display device according to claim 1, further comprising a viewer-side Pancharatnam-Berry lens between the circularly polarized light-selective reflector and the viewer.

5. A head-mounted display comprising: the display device according to claim 1, and a wearable part to be worn on a head of the viewer.
